(19) United States
(12) Patent Application Publication
(10) Pub. No.: US 2019/0199542 A1
(43) Pub. Date: Jun. 27, 2019

(54) INFORMATION PROVIDING SYSTEM, INFORMATION PROVIDING APPARATUS, AND INFORMATION PROVIDING METHOD

(71) Applicant: Tsutomu KINOMOTO, Kanagawa (JP)

(72) Inventor: Tsutomu KINOMOTO, Kanagawa (JP)

(21) Appl. No.: 16/182,648

(22) Filed: Nov. 7, 2018

(30) Foreign Application Priority Data
Dec. 27, 2017 (JP) 2017-252640

(51) Int. Cl. H04L 12/18; G06Q 10/10; G06Q 10/06

(52) U.S. Cl. CPC H04L 12/1818; G06Q 10/06314; G06Q 10/1095

(57) ABSTRACT

An information providing system includes one or more processors. The one or more processors is configured to store, in a memory, for each of one or more meeting resources, information on the meeting resource and security information of the meeting resource in association with each other. The one or more processors are configured to receive an input of a meeting holding condition. The one or more processors are configured to acquire information on at least one of the one or more meeting resources that matches the meeting holding condition from among the one or more meeting resources based on security information corresponding to the meeting holding condition. The one or more processors are configured to provide the information on the at least one of the one or more meeting resources.

### CROSS-REFERENCE TO RELATED APPLICATION

This patent application is based on and claims priority pursuant to 35 U.S.C. § 119(a) to Japanese Patent Application No. 2017-252640, filed on Dec. 27, 2017, the entire disclosure of which is incorporated herein by reference.

### BACKGROUND

### Technical Field

The present disclosure relates to an information providing system, an information providing apparatus, and an information providing method.

### Description of the Related Art

Conference systems are known that allow users at remote places to hold a remote conference via a network such as the Internet or a local area network (LAN).

For example, remote conference systems are known that perform a remote conference using a portable conference apparatus including a camera or the like.

### SUMMARY

An information providing system includes one or more processors. The one or more processors is configured to store, in a memory, for each of one or more meeting resources, information on the meeting resource and security information of the meeting resource in association with each other. The one or more processors are configured to receive an input of a meeting holding condition. The one or more processors are configured to acquire information on at least one of the one or more meeting resources that matches the meeting holding condition from among the one or more meeting resources based on security information corresponding to the meeting holding condition. The one or more processors are configured to provide the information on the at least one of the one or more meeting resources.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating an example of a system configuration of an information providing system, according to an embodiment of the present disclosure;

FIG. 2 is a block diagram illustrating an example of a hardware configuration of a computer, according to an embodiment of the present disclosure;

FIG. 3 is a block diagram illustrating an example of a functional configuration of the information providing system, according to an embodiment of the present disclosure;

FIG. 4A is a table illustrating an example of meeting holding information managed by a meeting management apparatus, according to an embodiment of the present disclosure;

FIG. 4B is a table illustrating an example of presentation material information managed by the meeting management apparatus, according to an embodiment of the present disclosure;

FIG. 5 is a table illustrating an example of attendee information managed by the meeting management apparatus, according to an embodiment of the present disclosure;

FIG. 6A is a table illustrating an example of meeting history information managed by the meeting management apparatus, according to an embodiment of the present disclosure;

FIG. 6B is a table illustrating an example of meeting resource information managed by the meeting management apparatus, according to an embodiment of the present disclosure;

FIG. 7A is a table illustrating an example of resource reservation information managed by the meeting management apparatus, according to an embodiment of the present disclosure;

FIG. 7B is a table illustrating an example of security levels of resource, according to an embodiment of the present disclosure;

FIG. 8A is a table illustrating an example of meeting room information managed by a resource management apparatus, according to an embodiment of the present disclosure;

FIG. 8B is a table illustrating an example of security levels of a meeting room, according to an embodiment of the present disclosure;

FIG. 9A is a table illustrating an example of device information managed by the resource management apparatus, according to an embodiment of the present disclosure;

FIG. 9B is a table illustrating an example of security levels of a device, according to an embodiment of the present disclosure;

FIG. 10A is a table illustrating an example of employee information managed by a personnel management apparatus, according to an embodiment of the present disclosure;

FIG. 10B is a table illustrating an example of outside corporate staff information managed by the personnel management apparatus, according to an embodiment of the present disclosure;

FIG. 11 is a sequence diagram illustrating an example of a registration process, according to a first embodiment of the present disclosure;

FIG. 12 is a sequence diagram illustrating an example of an information providing process, according to the first embodiment of the present disclosure;

FIG. 13 is a block diagram illustrating an example of a functional configuration of the information providing system, according to a second embodiment of the present disclosure;

FIG. 14A is a table illustrating an example of alternative device information managed by an alternative resource management unit, according to the second embodiment of the present disclosure;

FIG. 14B is a table illustrating an example of alternative software information managed by the alternative resource management unit, according to the second embodiment of the present disclosure;

FIG. 15 is a table illustrating an example of alternative meeting room information managed by the alternative resource management unit, according to the second embodiment of the present disclosure;

FIG. 16 is a sequence diagram illustrating an example of an information providing process, according to the second embodiment of the present disclosure;

FIG. 17 is a block diagram illustrating an example of a functional configuration of the information providing system, according to a third embodiment of the present disclosure;

FIG. 18 is a sequence diagram illustrating an example of a setting process, according to a third embodiment of the present disclosure;

FIG. 19 is a sequence diagram illustrating another example of the setting process, according to the third embodiment of the present disclosure;

FIG. 20 is a sequence diagram illustrating still another example of the setting process, according to the third embodiment of the present disclosure;

FIG. 21 is a sequence diagram illustrating still another example of the setting process, according to the third embodiment of the present disclosure; and

FIG. 22 is a sequence diagram illustrating still another example of the setting process, according to the third embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Referring to the drawings, one or more embodiments of the present disclosure are described.

System Configuration:

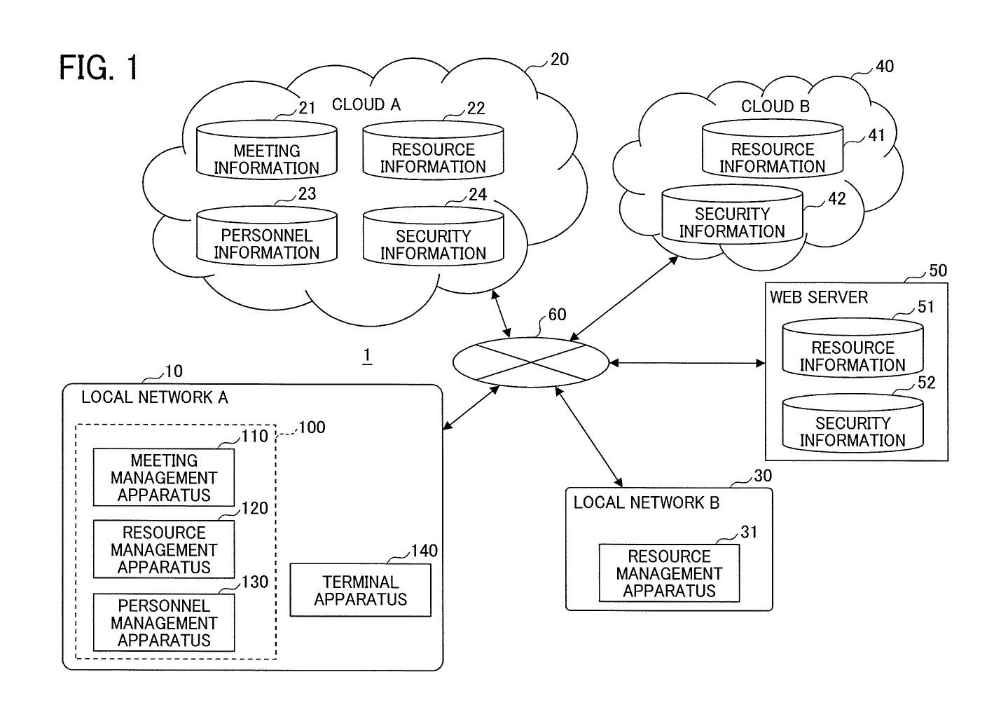

FIG. 1 is a diagram illustrating an example of a system configuration of an information providing system 1 according to an embodiment of the present disclosure. The information providing system 1 is a system for providing information about meeting resources depending on conditions for holding a meeting, using a meeting management apparatus 110, a resource management apparatus 120, a personnel management apparatus 130, etc., provided in a local network A 10.

In FIG. 1, the meeting management apparatus 110, the resource management apparatus 120, and the personnel management apparatus 130 are provided in the local network A 10 such as an intra-enterprise network. The meeting management apparatus 110, the resource management apparatus 120, and the personnel management apparatus 130 can exchange data or information with each other.

The meeting management apparatus 110 is, for example, an information processing apparatus such as a personal computer (PC) or a system including a plurality of information processing apparatuses. The meeting management apparatus 10 manages a procedure of holding a meeting, presentation materials, participants, a meeting history, a reservation for meeting resources. For example, the meeting management apparatus 110 stores meeting information 21 in a server such as a cloud A 20 to manage the meeting information 21. Examples of the meeting information 21 include meeting holding information, presentation materials, attendee information, meeting history information, and reservation information on meeting resources.

Further, the meeting management apparatus 110 receives conditions for holding a meeting, the conditions being input by a user who is going to use meeting resources using a terminal apparatus 140. The meeting management apparatus 110 provides information on meeting resources according to the received conditions for holding a meeting. For example, the meeting management apparatus 110 causes the terminal apparatus 140 to display the information on the meeting resources that satisfy the conditions for holding a meeting input by the user to the terminal apparatus 140.

The resource management apparatus 120 is, for example, an information processing apparatus such as a personal computer (PC) or a system including a plurality of information processing apparatuses. The resource management apparatus 120 manages information on meeting resources such as meeting rooms or devices that can be used in a meeting in association with security information on the meeting resources. For example, the resource management apparatus 120 stores, in a server such as the cloud A 20, resource information 22 including meeting room information to which security information is assigned and device information to which security information is assigned, to manage the resource information 22.

The security information is represented by, for example, security levels that indicate stepwise levels of security required for meetings. A security content (e.g., presence or absence of security, encryption of communication, presence or absence of authentication) corresponding to each of the security levels is stored in security information 24 stored in the cloud A 20, for example.

The personnel management apparatus 130 is, for example, an information processing apparatus such as a personal computer (PC) or a system including a plurality of information processing apparatuses. The personnel management apparatus 130 manages users such as employees or outside corporate staffs, costs required for holding a meeting, and the like. For example, the personnel management apparatus 130 stores, in a server such as the cloud A 20, personnel information 23 including information such as a name, division and location of each of employees and outside corporate staffs, and information on costs, and manages the personnel information 23.

Preferably, the information providing system 1 can refer to resource information 41, security information 42, etc., that are stored in a cloud B 40 and managed by a resource management apparatus 31 provided in a local network B 30 of another company such as a rental company.

Further, the information providing system 1 can have a function of acquiring software information 51 or device information 52 from a web server (external server) 50 provided by a vendor of devices or software for use in a meeting and assigning security information to the acquired information to manage the software information 51 and device information 52.

The configuration illustrated in FIG. 1 is just an example of the configuration of the information providing system 1, and the information providing system 1 may have any other suitable system configuration. In another example, the meeting management apparatus 110 stores the meeting information 21 in a server apparatus provided in the local network A 10 or a memory of the meeting management apparatus 110 and manages the meeting information 21. In a similar manner, the resource management apparatus 120 can store the resource information 22 in a server apparatus provided in the local network A 10 or a memory of the resource management apparatus 120, to manage the resource information 22. Further, the personnel management apparatus 130 can store the personnel information 23 in a server apparatus provided in the local network A 10 or a memory of the personnel management apparatus 130, to manage the personnel information 23.

In still another example, the meeting management apparatus 110, the resource management apparatus 120, and the personnel management apparatus 130 can be configured as one information providing apparatus 100.

<Hardware Configuration>

Next, a description is given of hardware configurations of the meeting management apparatus 110, the resource management apparatus 120, and the personnel management apparatus 130. Each of the meeting management apparatus 110, the resource management apparatus 120, and the personnel management apparatus 130 has a hardware configuration of a general-purpose computer.

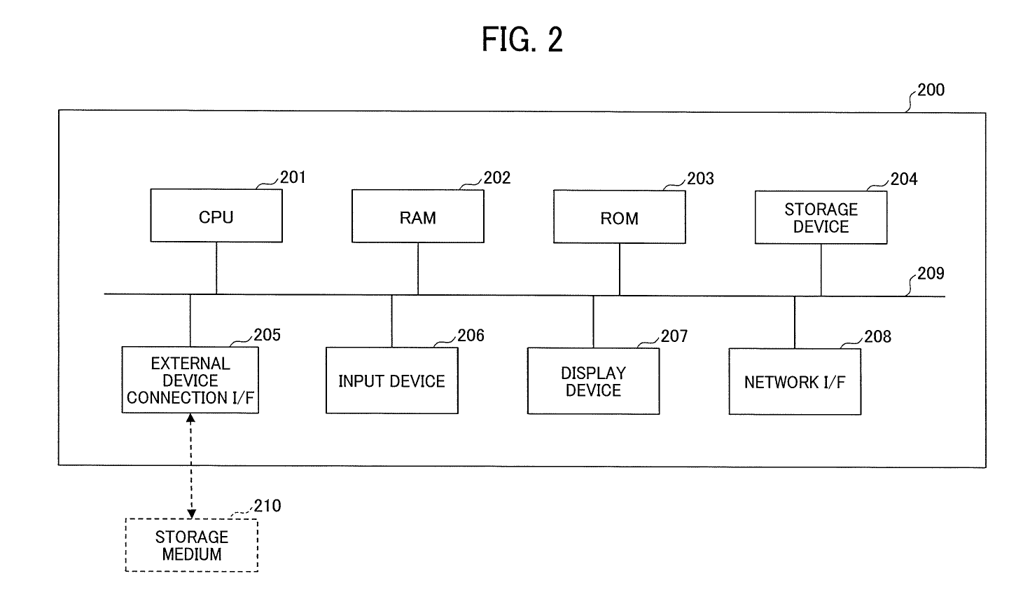

FIG. 2 is a block diagram illustrating an example of a hardware configuration of a general-purpose computer 200, that can be used as the meeting management apparatus 110, the resource management apparatus 120, and the personnel management apparatus 130, according to an embodiment of the present disclosure. The computer 200 includes, for example, a central processing unit (CPU) 201, a random access memory (RAM) 202, a read only memory (ROM) 203, a storage device 204, an external device connection interface (I/F) 205, an input device 206, a display device 207, a network I/F 208, and a bus 209.

The CPU 201 is an arithmetic device that reads programs or data from the ROM 203 or the storage device 204 onto the RAM 202, and executes processing according to the programs or data, to implement functions of the computer 200. The RAM 202 is a volatile memory used as a work area of the CPU 201. The ROM 203 is a nonvolatile memory, which holds programs or data even after the computer 200 is turned off as the power is not supplied.

The storage device 204 is a device such as a hard disc drive (HDD) or a solid state drive (SSD). The storage device 204 stores an operating system (OS), an application program, and various types of data.

The external device connection I/F 205 is an interface that connects the computer 200 to external devices. Examples of the external devices connected to the computer 200 via the external device connection I/F 205 include a storage medium 210. The external device connection I/F 205 enables the computer 200 to read or write data from or to the storage medium 210. The computer 200 installs a predetermined program stored in the storage medium 210 via the external device connection I/F 205 on the computer 200 to execute the predetermined program.

The input device 206 is a device for receiving an input according to a user operation. Examples of the input device 206 include a mouse, a keyboard, and a touch panel. The display device 207 is a device for displaying various information, such as a display.

The network I/F 208 is an interface that connects the computer 200 to a network 60. The network I/F 208 enables the computer 200 to communicate data with other devices or apparatuses via the network 60. The bus 209 is connected to each of the above-mentioned components, and transfers address signals, data signals, and various types of control signals.

The configuration illustrated in FIG. 2 is just an example of the configuration of the computer 200 as the meeting management apparatus 110, the resource management apparatus 120 and the personnel management apparatus 130, and the computer 200 may have any other suitable hardware configuration. In another example, the meeting management apparatus 110, the resource management apparatus 120, and the personnel management apparatus 130 do not necessarily have to include the input device 206 and/or the display device 207. In still another example, the meeting management apparatus 110, the resource management apparatus 120, the personnel management apparatus 130 is configured as a combination of a plurality of computers 200. In still another example, the meeting management apparatus 110, the resource management apparatus 120, the personnel management apparatus 130 is implemented by an electronic device having a configuration of a general-purpose computer, e.g., an image forming apparatus.

<Functional Configuration>

Next, a description is given of functional configurations of the meeting management apparatus 110, the resource management apparatus 120, and the personnel management apparatus 130.

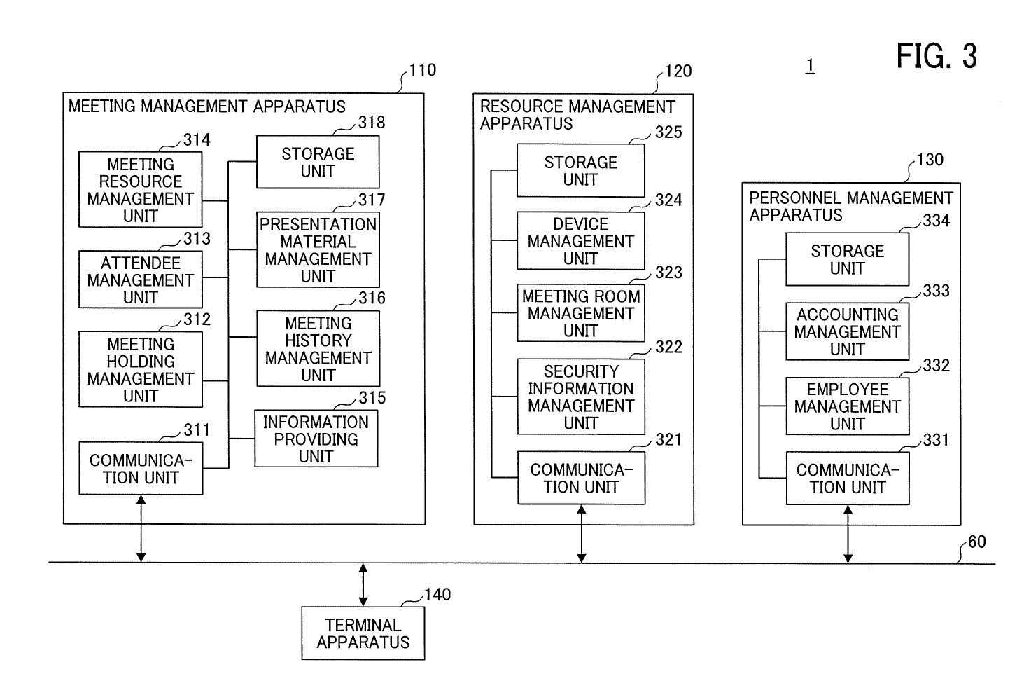

FIG. 3 is a block diagram illustrating an example of a functional configuration of the information providing system 1 according to an embodiment of the present disclosure.

Functional Configuration of Meeting Management Apparatus 110:

The meeting management apparatus 110 includes, for example, a communication unit 311, a meeting holding management unit 312, an attendee management unit 313, a meeting resource management unit 314, an information providing unit 315, a meeting history management unit 316, a presentation material management unit 317, and a storage unit 318. Each of the above-described functional units of the meeting management apparatus 110 is implemented by the CPU 201 of FIG. 2 executing the predetermined program.

The communication unit 311 connects the meeting management apparatus 110 to the network 60, using the network I/F 208 illustrated in FIG. 2, and communicates data with the resource management apparatus 120, the personnel management apparatus 130, and the terminal apparatus 140.

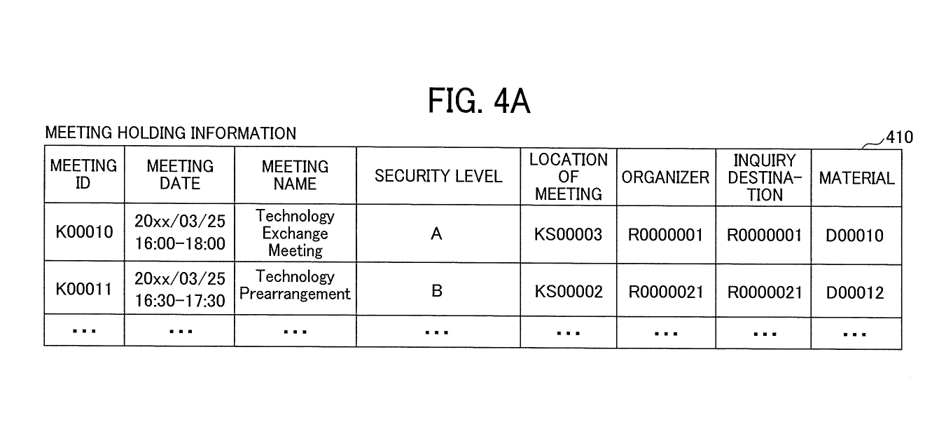

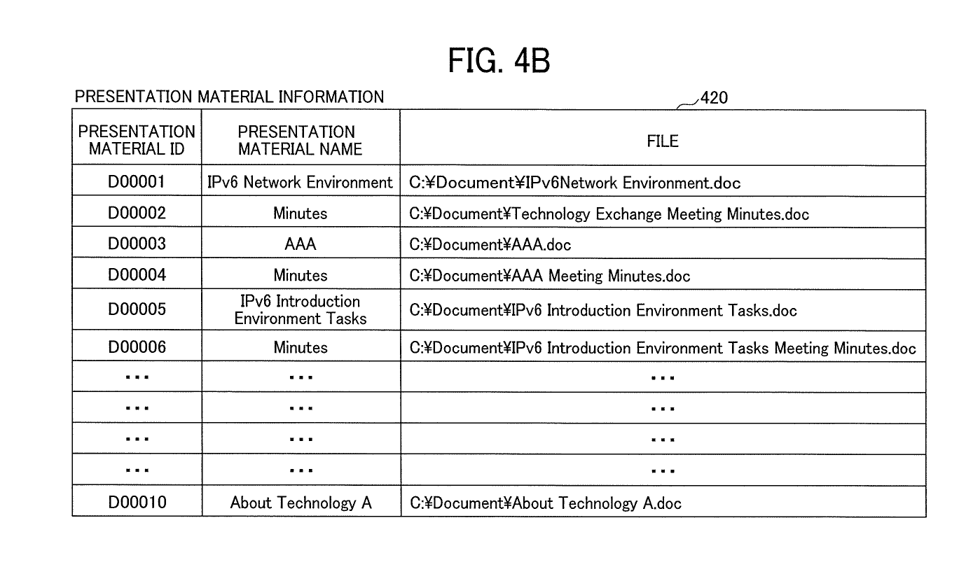

The meeting holding management unit 312 receives input (registration) of conditions for holding a meeting from a user who is going to hold a meeting such as a remote conference. The conditions for holding a meeting include, for example, information on a date and time of the meeting, a name of the meeting, attendees, the security level, and the like. Further, the meeting holding management unit 312 stores, from among the registered (input) information, information on the date and time of the meeting, the name of the meeting, the security level, a location where the meeting is to be held, presentation material and the like in meeting holding information 410 as illustrated in FIG. 4B, to manage these items of information.

FIG. 4A illustrates an example of the meeting holding information 410, according to one embodiment of the present disclosure. In the example of FIG. 4A, the meeting holding information 410 includes information of “meeting ID”, “meeting date”, “meeting name”, “security level”, “location of meeting”, “organizer”, “inquiry destination”, and “material”. The “meeting ID” is identification information for identifying a meeting. The “meeting date” is information indicating a date and time at which the meeting is to be held. The “meeting name” is information indicating a name of the meeting.

The “security level” is information indicating stepwise how high the security of the meeting is. For example, the security level is set by a user who is going to hold the meeting. In the present embodiment, a description is given hereinafter assuming that the security levels are classified into four levels of “-”, “C”, “B”, and “A”. In this example, “A” corresponds to the highest security level and “-” (indicating no security) corresponds to the lowest security level. In addition, in the present embodiment, the higher the security level, the higher the cost. Further, the higher importance of a meeting, and/or the higher confidentiality of a meeting, the higher security level is set.

The “location of meeting” is information indicating a place where the meeting is held, such as a meeting room. The “location of meeting” is represented by, for example, a meeting room ID managed by the resource management apparatus 120. The “organizer” is information indicating, for example, host organizing the meeting or a person who is responsible for the meeting. The “organizer” is represented by, for example, an employee ID or the like managed by an employee management unit 332 of the personnel management apparatus 130. The “inquiry destination” is information indicating a destination to which an inquiry about the meeting is to be sent. The “inquiry destination” is represented by, for example, an employee ID or the like managed by the employee management unit 332 of the personnel management apparatus 130. The “material” is information on presentation materials to be used in the meeting. The “material” is represented by, for example, a presentation material ID or the like managed by the presentation material management unit 317 described later.

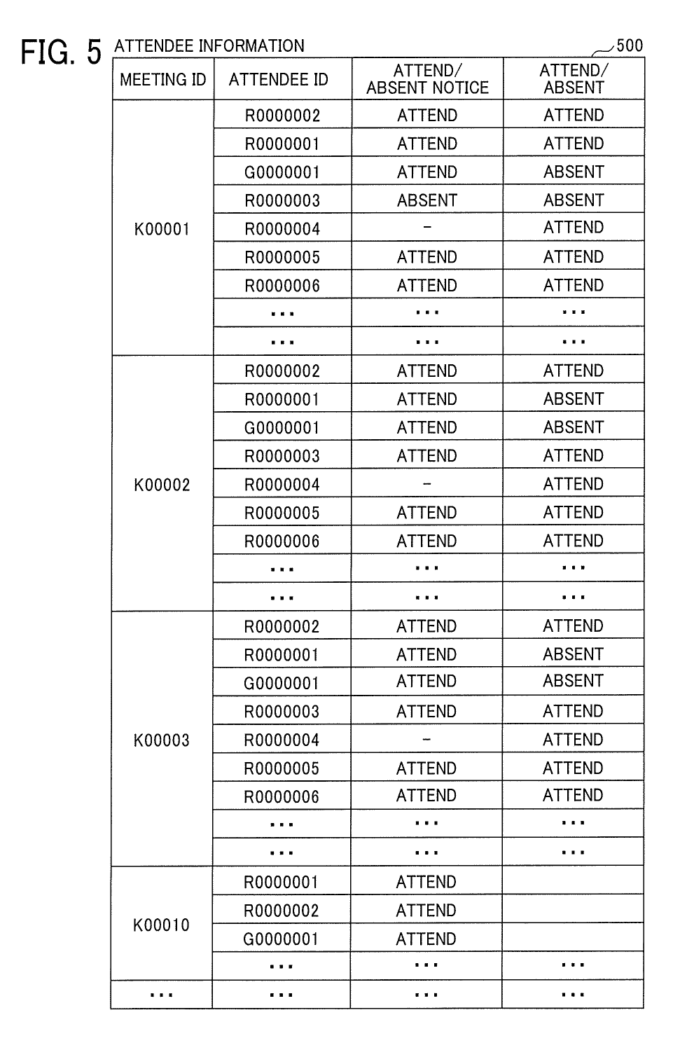

The attendee management unit 313 stores information on attendees of the meeting received by the meeting holding management unit 312 in attendee information 500 as illustrated in FIG. 5, for example, to manage the information on attendees.

FIG. 5 illustrates an example of the attendee information 500, according to one embodiment of the present disclosure. In the example of FIG. 5, the attendee information 500 includes information of “meeting ID”, “attendee ID”, “attend/absent notice”, and “attend/absent”.

The “meeting ID” is identification information for identifying a meeting. This “meeting ID” corresponds to the “meeting ID” included in the meeting holding information 410 managed by the meeting holding management unit 312. The “attendee ID” is information for identifying an attendee who participates in the meeting. The “attendee ID” is represented by, for example, an employee ID or the like managed by the employee management unit 332 of the personnel management apparatus 130. In the “attend/absent notice”, information is stored information is stored indicating attendance or absence of each participant registered in advance of the holding of the meeting. In the “attend/absent”, information is stored indicating whether each attendee participated in the meeting or not. The meeting resource management unit 314 acquires, from the resource management apparatus 120, information on meeting resources that satisfy conditions for holding a meeting, based on the security information corresponding to the conditions for holding a meeting received by the meeting holding management unit 312. For example, the meeting resource management unit 314 acquires, from the resource management apparatus 120, information on meeting resources (a meeting room, a device, etc.) that satisfy the security level included in the conditions for holding a meeting received by the meeting holding management unit 312.

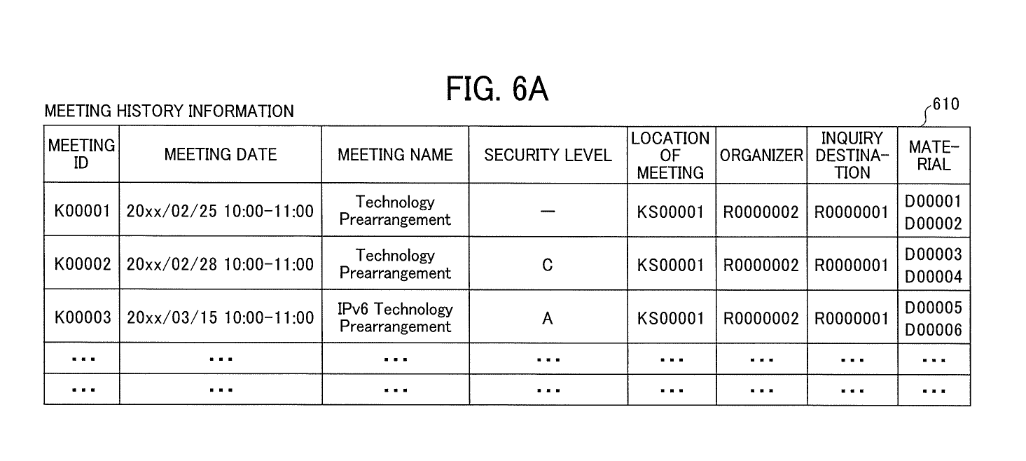

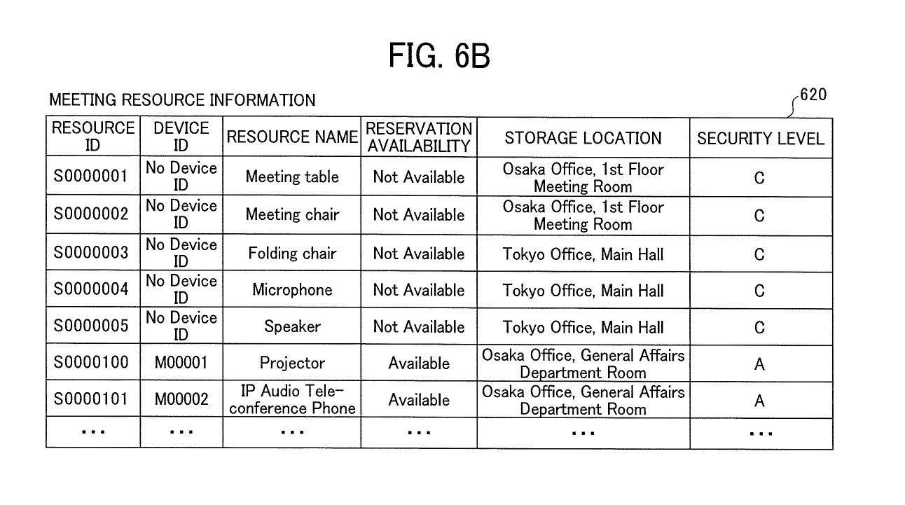

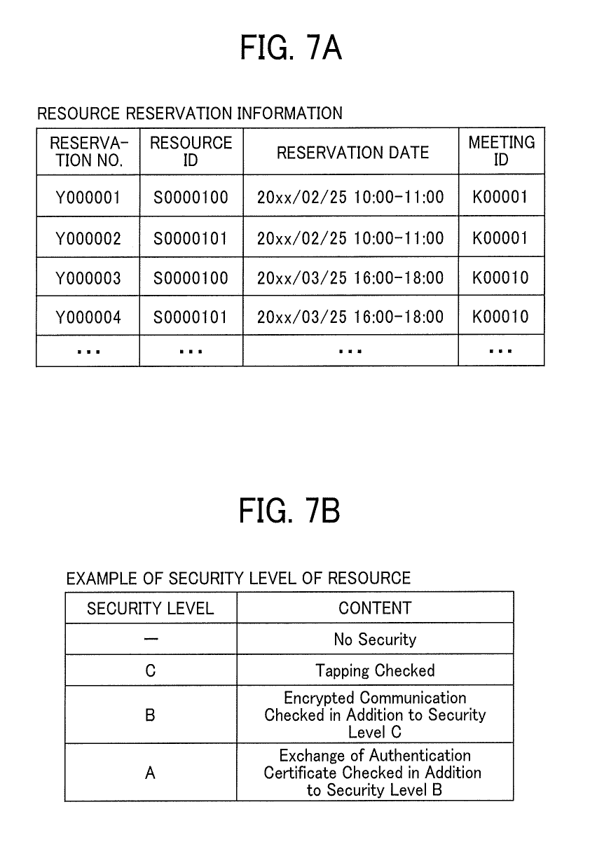

Further, the meeting resource management unit 314 stores information on resources used in a meeting in meeting resource information 620 as illustrated in FIG. 6B, to manage the information on resources. Further, the meeting resource management unit 314 stores a reservation status of resources used in a meeting in resource reservation information 710 as illustrated in FIG. 7A, to manage the reservation status.

FIG. 6B illustrates an example of the meeting resource information 620, according to one embodiment of the present disclosure. In the example of FIG. 6B, the meeting resource information 620 includes information of “resource ID”, “device ID”, “resource name”, “reservation availability”, “storage location”, and “security level”.

The “resource ID” is identification information for identifying a resource. The “device ID” is identification information for identifying a device, in a case where the resource is a device. The “device ID” is represented by, for example, a device ID managed by the resource management apparatus 120. The “resource name” is information indicating a name of the resource. The “reservation availability” is information indicating whether the resource is available for reservation or not. The “storage location” is information indicating a location where the resource is kept.

The “security level” is information indicating a security level of the resource. This “security level” corresponds to the “security level” included in the meeting holding information 410 of FIG. 4A, for example. FIG. 7B illustrates an example of the security level of resource. The security level of resource is classified into four levels of “-”, “C”, “B”, and “A” in substantially the same manner as the “security level” included in the meeting holding information 410. Further, with respect to the security level of resource, a security content of resource is defined for each of the security levels, as illustrated in FIG. 7B. The security level of resource is stored in advance in the security information 24 stored in the cloud A 20 of FIG. 1, for example.

FIG. 7A illustrates an example of the resource reservation information 710, according to one embodiment of the present disclosure. In the example of FIG. 7A, the resource reservation information 710 includes information of “reservation number”, “resource ID”, “reservation date”, and “meeting ID”.

The “reservation number” is identification information for identifying a reservation of a resource. The “resource ID” is identification information for identifying the resource. This “resource ID” corresponds to, for example, the “resource ID” included in meeting resource information 620 described above with reference to FIG. 6B. The “reservation date” is information indicating a date and time for which the resource is reserved. The “meeting ID” is identification information for identifying a meeting. This “meeting ID” corresponds to, for example, the “meeting ID” included in the meeting holding information 410 described above with reference to FIG. 4A.

Referring again to FIG. 3, the functional configuration of the meeting management apparatus 110 is further described.

The information providing unit 315 provides information on meeting resources that satisfy the conditions for holding a meeting received by the meeting holding management unit 312.

For example, in response to receiving the conditions for holding a meeting including the security level (security information) by the meeting holding management unit 312, the meeting resource management unit 314 acquires information on a meeting resource corresponding to the security level from the resource management apparatus 120. The information providing unit 315 causes the terminal apparatus 140 to display the information on a meeting resource corresponding to the security level included in the conditions for holding a meeting acquired by the meeting resource management unit 314.

This enables a user who is making a reservation for a meeting using the terminal apparatus 140 to select a meeting resource according to the security level of the meeting in a relatively simple manner.

The meeting history management unit 316 stores information of a history of meetings that were held in meeting history information 610 as illustrated in FIG. 6A, to manage the information on the history of meetings.

FIG. 6A illustrates an example of the meeting history information 610, according to one embodiment of the present disclosure. In the example of FIG. 6A, the meeting history information 610 includes information of “meeting ID”, “meeting date”, “meeting name”, “security level”, “location of meeting”, “organizer”, “inquiry destination”, and “material”.

From among those items of information stored in the meeting history information 610, information of the “meeting ID”, “meeting name”, “security level”, “location of meeting”, “organizer”, “inquiry destination” and “material” respectively correspond to the “meeting ID”, “meeting name”, “security level”, “location of meeting”, “organizer”, “inquiry destination” and “material” included in the meeting holding information 410 described above with reference to FIG. 4A. In the “meeting date”, a start date and time and an end date and time of a meeting that was actually held are stored.

The presentation material management unit 317 stores information on presentation materials and/or minutes registered by an organizer of a meeting, attendees or the like in presentation material information 420 as illustrated in FIG. 4B, to manage the information on presentation materials and/or minutes.

FIG. 4B illustrates an example of the presentation material information 420, according to one embodiment of the present disclosure. In the example of FIG. 4B, the presentation material information 420 stores information of “presentation material ID”, “presentation material name” and “file”.

The “presentation material ID” is identification information for identifying presentation material. The “presentation material name” is information on a name of the presentation material. The “file” is information indicating a file in which the presentation material is stored or a source from which the file is acquired.

The meeting holding information 410, the presentation material information 420, the attendee information 500, the meeting history information 610, the meeting resource information 620, and the resource reservation information 710 are included in the meeting information 21 stored, for example, in the cloud A 20 of FIG. 1. In another example, one or more of the above-described information can be stored in a server apparatus provided in the local network A 10 or in the storage unit 318 of the meeting management apparatus 110.

The storage unit 318 is implemented by, for example, a program executed by the CPU 201 and the storage device 204 of FIG. 2, for example. The storage unit 318 can store various information including each item of the above-mentioned information.

Functional Configuration of Resource Management Apparatus 120:

The resource management apparatus 120 includes, for example, a communication unit 321, a security information management unit 322, a meeting room management unit 323, a device management unit 324, and a storage unit 325.

Each of the above-described functional units of the resource management apparatus 120 is implemented by the CPU 201 of FIG. 2 executing the predetermined program.

The communication unit 321 connects the resource management apparatus 120 to the network 60, using the network I/F 208 illustrated in FIG. 2, and communicates data with other apparatuses such as the meeting management apparatus 110.

The security information management unit 322 manages security information (security level) of each meeting resource. For example, the security information management unit 322 assigns security level information to meeting room information 810 (described later) managed by the meeting room management unit 323. Further, the security information management unit 322 assigns security level information to device information 910 (described later) managed by the device management unit 324.

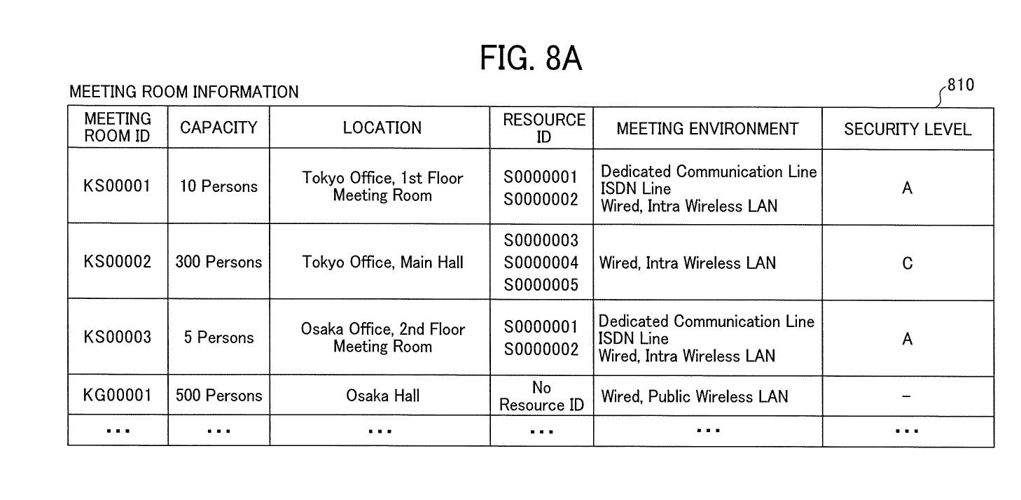

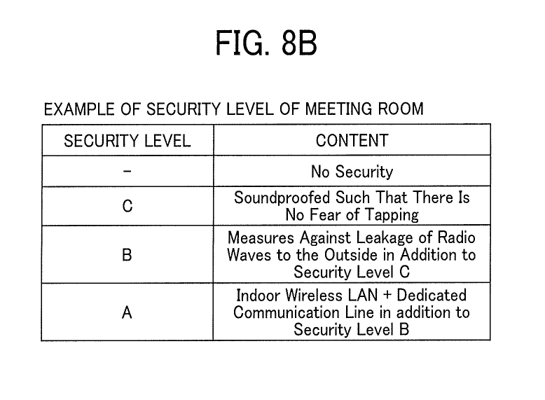

The meeting room management unit 323 stores information on a meeting room, from among meeting resources, in the meeting room information 810 as illustrated in FIG. 8A, to manage the information on a meeting room. The meeting room is an example of a place where a meeting is held.

FIG. 8A illustrates an example of the meeting room information 810, according to one embodiment of the present disclosure. In the example of FIG. 8A, the meeting room information 810 includes information of “meeting room ID”, “capacity”, “location”, “resource ID”, “meeting environment”, and “security level”.

The “meeting room ID” is identification information for identifying a meeting room. The “capacity” is information indicating the maximum number of persons that the meeting room can accommodate. The “location” is information indicating a place or the like where a meeting room is provided. The “resource ID” is information on resource provided in the meeting room. This “resource ID” corresponds to, for example, “resource ID” included in the meeting resource information 620 of FIG. 6B. The “meeting environment” is information on communication facilities or the like provided in the meeting room.

The “security level” is information indicating a security level of the meeting room. This “security level” corresponds to, for example, the “security level” included in the meeting holding information 410 of FIG. 4A. FIG. 8B illustrates an example of the security level of a meeting room. The security level of a meeting room is classified into four levels of “-”, “C”, “B”, and “A” in substantially the same manner as the “security level” included in the meeting holding information 410. Further, with respect to the security level of a meeting room, a security content of a meeting room is defined for each of the security levels, as illustrated in FIG. 8B. The security level of a meeting room is stored in advance in the security information 24 stored in the cloud A 20 of FIG. 1, for example.

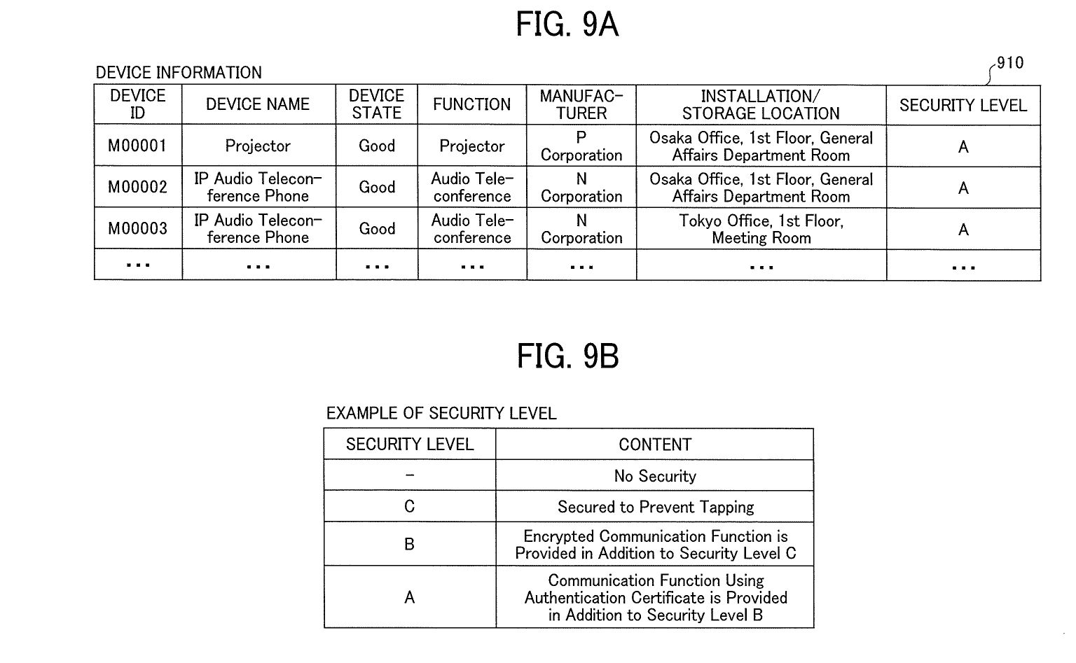

The device management unit 324 of FIG. 3 stores, in device information 910 as illustrated in FIG. 9A, information on devices to be used in a meeting from among meeting resources, to manage the information on devices. In one example, the device management unit 324 can further manage information on software to be used in a meeting.

FIG. 9A illustrates an example of the device information 910, according to one embodiment of the present disclosure. For example, the device information 910 includes information of “device ID”, “device name”, “device state”, “function”, “manufacturer”, “installation/storage location”, and “security level”.

The “device ID” is identification information for identifying a device. The “device name” is information indicating a name or the like of the device. The “device state” is information indicating a state of the device. For example, the “device state” indicates whether the device is in a “good” state in which the device operates normally, or in an “unusable” state in which the device does not operate normally. The “function” is information indicating a function, type or the like of the device. The “manufacturer” is information indicating a manufacturer, a vendor or the like of the device. The “installation/storage location” is information indicating a place where the device is installed or kept.

The “security level” is information indicating a security level of the device. This “security level” corresponds to the “security level” included in the meeting holding information 410 of FIG. 4A, for example. FIG. 9B illustrates an example of the security level of a device. The security level of a device is classified into four levels of “-”, “C”, “B”, and “A” in substantially the same manner as the “security level” included in the meeting holding information 410. Further, with respect to the security level of a device, a security content of a device is defined for each of the security levels, as illustrated in FIG. 9B. The security level of a device is stored in advance in the security information 24 stored in the cloud A 20 of FIG. 1, for example.

The meeting room information 810 and the device information 910 described above are included in the resource information 22 stored in the cloud A 20 of FIG. 1, for example. In another example, at least one of the meeting room information 810 and the device information 910 can be stored in a server apparatus provided in the local network A 10 or in the storage unit 325 of the resource management apparatus 120.

The storage unit 325 is implemented by, for example, a program executed by the CPU 201 and the storage device 204 of FIG. 2, for example. The storage unit 325 can store various information including each item of the above-mentioned information.

Functional Configuration of Personnel Management Apparatus 130:

The personnel management apparatus 130 manages various information concerning personnel affairs and accounting. The personnel management apparatus 130 includes, for example, an employee management unit 332, an accounting management unit 333, and a storage unit 334.

Each of the above-described functional units of the personnel management apparatus 130 is implemented by the CPU 201 of FIG. 2 executing the predetermined program.

The communication unit 331 connects the personnel management apparatus 130 to the network 60, using the network I/F 208 illustrated in FIG. 2, and communicates data with other apparatuses such as the meeting management apparatus 110.

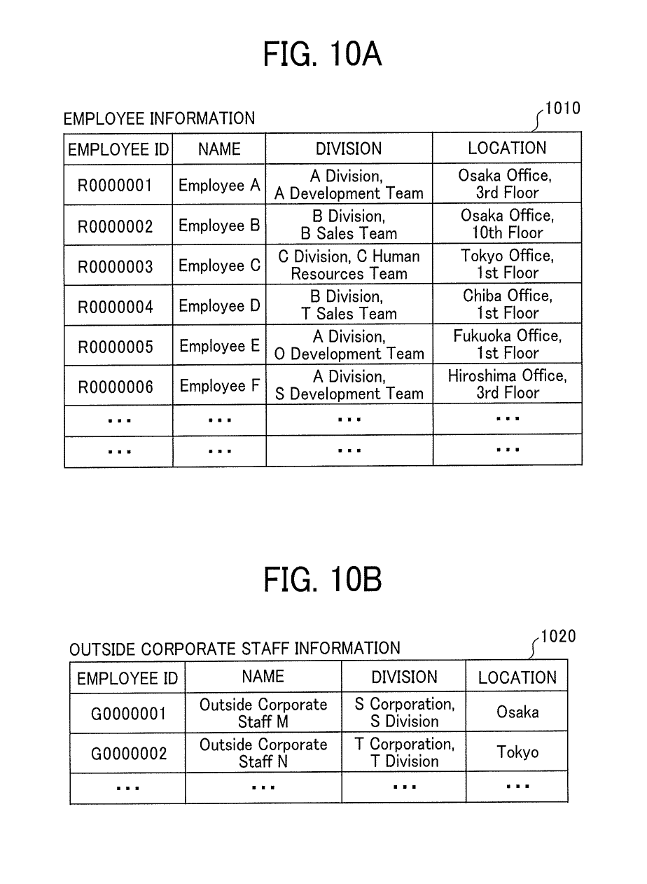

The employee management unit 332 stores information on employees of a company or the like that operates the local network A 10 in employee information 1010 as illustrated in FIG. 10A, to manage the information on employee. Further, the employee management unit 332 stores information on outside corporate staffs other than the employees in outside corporate staff information 1020 as illustrated in FIG. 10B.

FIG. 10A illustrates an example of the employee information 1010, according to one embodiment of the present disclosure. In the example of FIG. 10A, the employee information 1010 includes information of “employee ID”, “name”, “division”, and “location”.

The “employee ID” is identification information for identifying an employee. The “name” is information indicating the employee's name. The “division” is information indicating a division, a department or the like to which the employee belongs. The “location” is information indicating a location of the employee (for example, a place where a desk of the employee is present).

FIG. 10B illustrates an example of the outside corporate staff information 1020, according to one embodiment of the present disclosure. In the example of FIG. 10B, the outside corporate staff information 1020 includes information of “employee ID”, “name”, “division”, and “location”.

The “employee ID” is identification information for identifying an outside corporate staff such as a visitor from outside the company, an employee of a collaborating company. The “name” is information indicating a name of the outside corporate staff. The “division” is information indicating a division, a department or the like to which the outside corporate staff belongs. The “location” is information indicating a location of the outside corporate staff (for example, a place where a desk of the outside corporate staff is present).

The accounting management unit 333 manages accounting management information including information such as expense for holding a meeting. In the present embodiment, the accounting management information managed by the accounting management unit 333 can be in any suitable format, and a detailed description thereof is omitted below.

The employee information 1010, the outside corporate staff information 1020, and the accounting management information described above are included in the personnel information 23 stored in the cloud A 20 of FIG. 1, for example. In another example, one or more of the employee information 1010, the outside corporate staff information 1020 and the accounting management information can be stored in a server apparatus provided in the local network A 10 or in the storage unit 334 of the personnel management apparatus 130.

The storage unit 334 is implemented by, for example, a program executed by the CPU 201 and the storage device 204 of FIG. 2, for example. The storage unit 334 can store various information including each item of the above-mentioned information.

Operation:

Next, a description is given of an operation of providing information by the information providing system 1.

### First Embodiment

Security Information Registration Process:

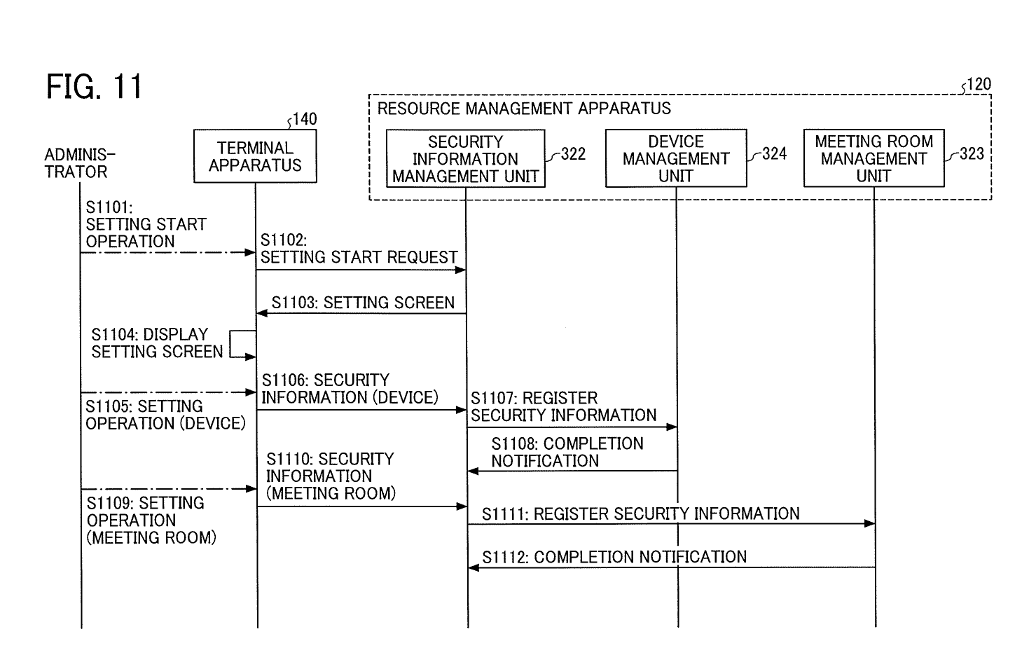

FIG. 11 is a sequence diagram illustrating an example of a registration process, according to a first embodiment. This process is an example of a process of registering the “security level” included in the meeting room information 810 illustrated in FIG. 8A and the “security level” included in the device information 910 illustrated in FIG. 8B. The “security level” is an example of security information.

In step S1101, for example, an administrator who manages the resource information 22 performs an operation to start setting the security information using the terminal apparatus 140. For example, the administrator uses a web browser of the terminal apparatus 140 to access a web page for setting the security information, the web page being provided by the security information management unit 322 of the resource management apparatus 120.

In step S1102, in response to the setting start operation by the administrator, the terminal apparatus 140 transmits, to the resource management apparatus 120, a setting start request that requests a start of setting the security information.

In steps S1103 and S1104, in response to the setting start request received from the terminal apparatus 140, the security information management unit 322 of the resource management apparatus 120 causes the terminal apparatus 140 to display a security information setting screen.

In step S1105, the administrator performs an operation to set the security information of a device on the security information setting screen. For example, via the security information setting screen, the administrator performs an operation to set the security level of a projector whose device ID is “M00001” to “A”, in the device information 910 illustrated in FIG. 9A.

In step S1106, the terminal apparatus 140 transmits the security information of the device that is set in step S1105 to the resource management apparatus 120.

In step S1107, the security information management unit 322 of the resource management apparatus 120 requests the device management unit 324 to register the security information of the device received from the terminal apparatus 140. Thus, for example, in the device information 910 illustrated in FIG. 9A, the security level of the projector whose device ID is “M00001” is set to “A”.

In step S1108, the device management unit 324 sends, to the security information management unit 322, a completion notification indicating that registration of the security information is completed.

In step S1109, the administrator performs an operation to set the security information of a meeting room on the security information setting screen. For example, via the security information setting screen, the administrator performs an operation to set the security level of a meeting room whose meeting room ID is “KS00001” to “A”, in the meeting room information 810 illustrated in FIG. 8A.

In step S1110, the terminal apparatus 140 transmits the security information of the meeting room that is set in step S1109 to the resource management apparatus 120.

In step S1111, the security information management unit 322 of the resource management apparatus 120 requests the meeting room management unit 323 to register the security information of the meeting room received from the terminal apparatus 140. Thus, for example, in the meeting room information 810 illustrated in FIG. 8A, the security level of the meeting room whose meeting room ID is “KS00001” is set to “A”. In step S1112, the meeting room management unit 323 sends, to the security information management unit 322, a completion notification indicating that registration of the security information is completed.

With the process from step S1101 to S1112, the administrator can register in advance the “security level” of the meeting room information 810 as illustrated in FIG. 8A and the “security level” of the device information 910 as illustrated in FIG. 9.

Information Providing Process by Information Providing System 1:

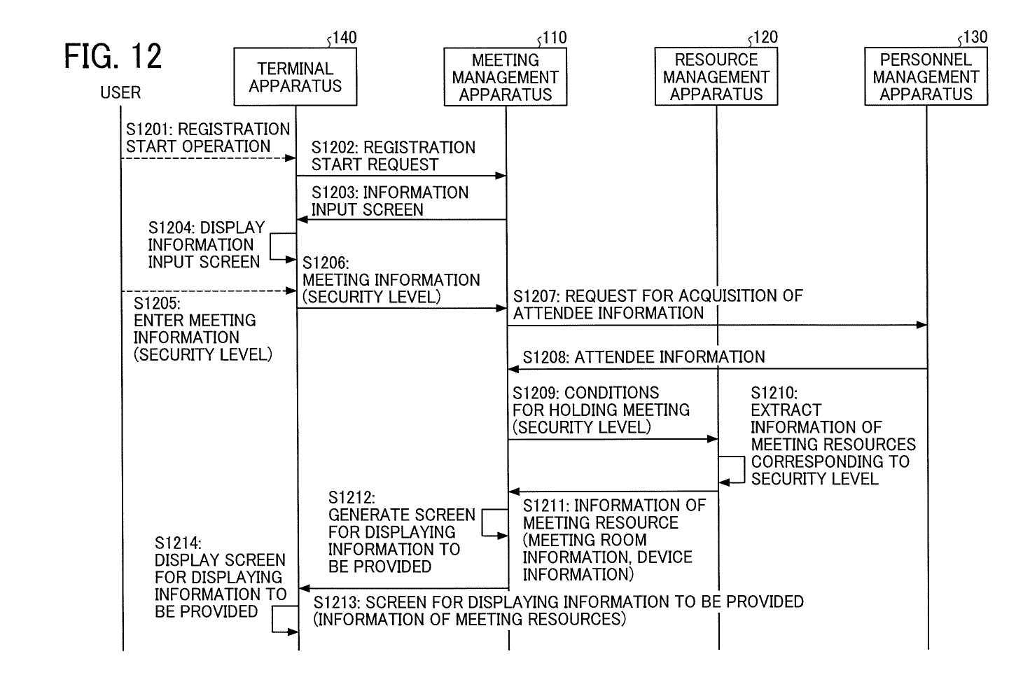

FIG. 12 is a sequence diagram illustrating an example of an information providing process, according to the first embodiment. This process is an example of a process in which the information providing system 1 provides information on meeting resources that satisfy conditions for holding a meeting based on the conditions for holding a meeting that are input by a user who is going to use the meeting resource. Prior to a start of the process illustrated in FIG. 12, the resource management apparatus 120 manages the information on meeting resources such as meeting rooms or devices in association with the security level that is preset for each of the meeting resources, through the security information registration process described above with reference to FIG. 11.

In step S1201, for example, a user who is going to use the meeting resources (e.g., an organizer who is holding a meeting) performs an operation to start registration of meeting information using the terminal apparatus 140. For example, the user uses the web browser of the terminal apparatus 140 to access a web page for registering the meeting information, the web page being provided by the meeting holding management unit 312 of the meeting management apparatus 110.

In step S1202, in response to the registration start operation by the user, the terminal apparatus 140 transmits, to the meeting management apparatus 110, a registration start request that requests a start of registration of the meeting information.

In steps S1203 and S1204, in response to the registration start request received from the terminal apparatus 140, the meeting holding management unit 312 of the meeting management apparatus 110 causes the terminal apparatus 140 to display an information input screen that enables the user to enter the meeting information.

In step S1205, the user enters the meeting information (conditions for holding a meeting) such as a date and time of the meeting, a name of the meeting, attendees, the security level, etc. on the displayed information input screen.

In step S1206, the terminal apparatus 140 transmits the meeting information that is entered by the user to the meeting management apparatus 110. The meeting information transmitted by the terminal apparatus 140 includes the security level of the meeting, which is an example of security information.

In steps S1207 and S1208, the attendee management unit 313 of the meeting management apparatus 110 acquires information on the attendees (name, division, location, etc.) from the personnel management apparatus 130.

In steps S1209 to S1211, the meeting resource management unit 314 of the meeting management apparatus 110 uses the security level included in the meeting information received by the meeting holding management unit 312 to acquire, from the resource management apparatus 120, information on meeting resources that match the security level.

For example, in step S1209, the meeting resource management unit 314 transmits conditions for holding a meeting including the meeting information acquired in step S1206 and the attendee information acquired in step S1208 to the resource management apparatus 120.

In step S1210, the meeting room management unit 323 and the device management unit 324 of the resource management apparatus 120 retrieve information on the meeting resources that satisfy the conditions for holding a meeting received from the meeting management apparatus 110.

For example, when the number of attendees at the meeting is three to four, the location is Osaka office, and the security level is A, the meeting room management unit 323 retrieves from the meeting room information 810 as illustrated in FIG. 8A, “Osaka office, 2nd floor meeting room” associated with the meeting room ID “KS00003”. In addition, when the attendees at the meeting include Employee C whose location is Tokyo office, the meeting room management unit 323 also retrieves “Tokyo office, 1st floor meeting room” associated with the meeting room ID “KS00001” from the meeting room information 810 illustrated in FIG. 8A.

In substantially the same manner, the device management unit 324 of the resource management apparatus 120 retrieves information on devices that satisfy the conditions for holding a meeting. For example, when the number of attendees at the meeting is three to four, the location is Osaka office, and the security level is A, the device management unit 324 retrieves a device whose device ID “M00001” and a device whose device ID “M00002” from the device information 910 as illustrated in FIG. 9A. In addition, when the attendees at the meeting include Employee C whose location is Tokyo office, the device management unit 324 retrieves an IP audio teleconference phone associated with the device ID “M00003” from the device information 910 as illustrated in FIG. 9A.

In step S1211, the resource management apparatus 120 notifies the meeting management apparatus 110 of information on the meeting resources, e.g., the meeting rooms and the devices retrieved in step S1210.

In step S1212, the information providing unit 315 of the meeting management apparatus 110 generates a display screen for providing information including the information of the meeting resources acquired through the process from step S1209 to S1211. For example, the information providing unit 315 generates a meeting information registration screen, on which the meeting rooms and the devices that match the security level of the meeting are displayed as being selectable.

In steps S1213 and S1214, the information providing unit 315 causes the terminal apparatus 140 to display the generated display screen for providing information.

In a conventional conference system, a user who is going to hold a meeting can select a desired meeting room or device, each being an example of meeting resources. In this case, the user cannot select the meeting resources according to conditions for holding a meeting. This may cause a problem in terms of security. For example, if the meeting room selected by the user provides inadequate security measures, there is a risk that a conversation in the meeting room leak to the outside, or someone eavesdrops a telephone conference conversation.

The information providing system 1 according to the present embodiment performs the above-described processes to retrieve the meeting resources corresponding to the conditions (security level or the like) for holding a meeting desired by the user who is going to hold a meeting and suggest the retrieved meeting resources to the user. Thus, the information providing system 1 according to the present embodiment provides information on meeting resources that match conditions for holding a meeting. This enables to ensure an appropriate security level depending on contents of a meeting.

### Second Embodiment

In a second embodiment, a description is given of an example in which information on alternative resources is provided when there is no available meeting resource that matches conditions for holding a meeting in the meeting resources managed by the resource management apparatus 120.

<Functional Configuration>

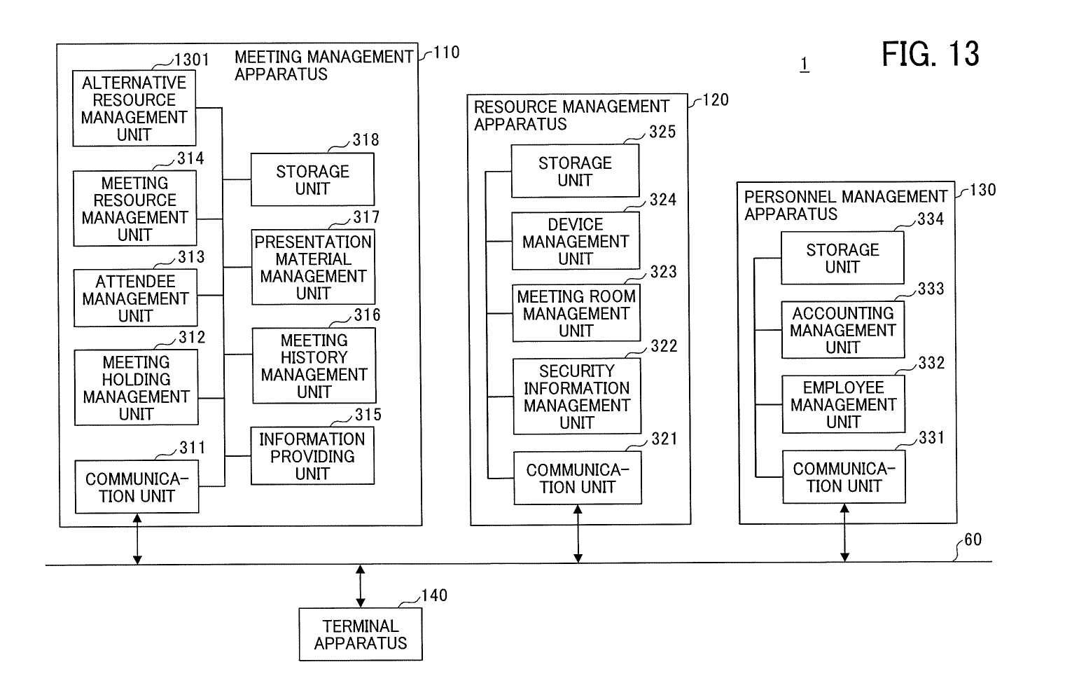

FIG. 13 is a block diagram illustrating an example of a functional configuration of the information providing system 1 according to the second embodiment of the present disclosure. As illustrated in FIG. 13, the information providing system 1 according to the second embodiment includes an alternative resource management unit 1301 in addition to the functional configuration of the information providing system 1 according to the first embodiment illustrated in FIG. 3. A description is provided below of an example in which the alternative resource management unit 1301 is included in the meeting management apparatus 110. In another example, the alternative resource management unit 1301 can be included in the resource management apparatus 120 or the like.

The alternative resource management unit 1301 is implemented by, for example, a program executed by the CPU 201 of FIG. 2. The alternative resource management unit 1301 acquires, from device manufacturers, software manufacturers, rental companies, or the like, information on alternative resources that can be substituted for the meeting resources managed by the resource management apparatus 120. Further, the alternative resource management unit 1301 assigns a security level to each of the acquired alternative resources, to manage information of the alternative resources.

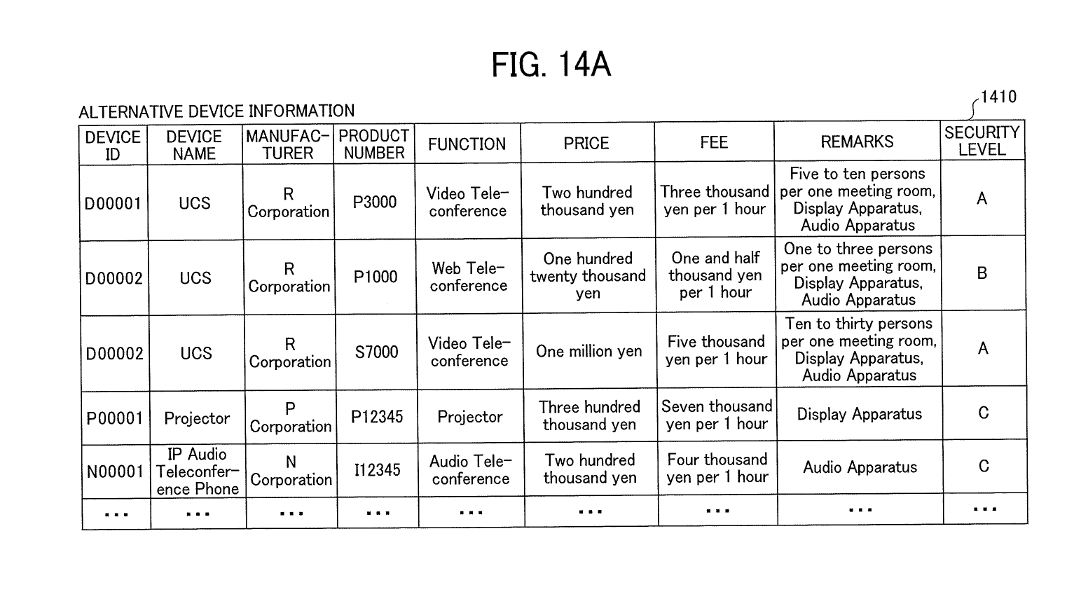

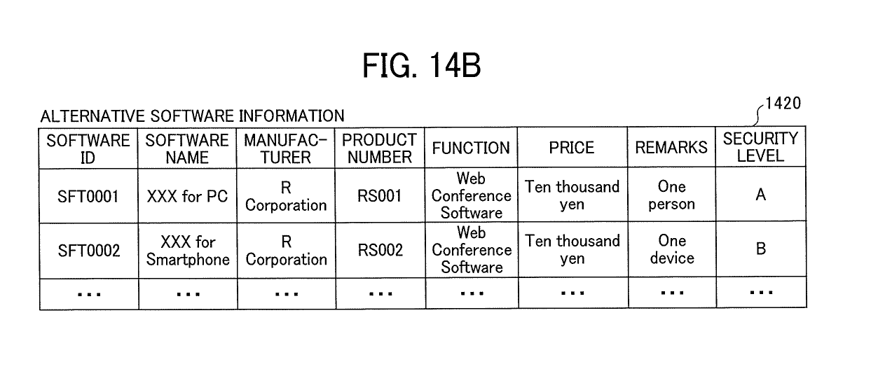

For example, the alternative resource management unit 1301 acquires information on alternative devices from the web server 50 operated by a device manufacturer or from the resource information 41 managed by the resource management apparatus 31 of a rental company. Further, the alternative resource management unit 1301 assigns a security level to the acquired information on the alternative devices. The alternative resource management unit 1301 stores and manages the information on the alternative devices associated with the security level in alternative device information 1410 as illustrated in FIG. 14A.

For example, the alternative resource management unit 1301 refers to the security level in the device information 910 as illustrated in FIG. 9A included in the resource information 22 stored in the cloud A 20 to determine the “security level” to be stored in the alternative device information 1410. In another example, the alternative resource management unit 1301 determines the “security level” to be stored in the alternative device information 1410, based on (e.g., by converting) a security level provided from a device manufacturer or a rental company. In still another example, the alternative resource management unit 1301 determines the “security level” to be stored in the alternative device information 1410 based on a security level entered by the administrator or the like.

Further, the alternative resource management unit 1301 acquires information on alternative software from the web server 50 operated by a software manufacturer or from the resource information 41 managed by the resource management apparatus 31 of a rental company. The alternative resource management unit 1301 assigns a security level to the acquired information on alternative software. The alternative resource management unit 1301 stores and manages the information on the alternative software associated with the security level in alternative software information 1420 as illustrated in FIG. 14B. For example, the “security level” to be stored in the alternative software information 1420 is determined in substantially the same manner as the “security level” stored in the alternative device information 1410.

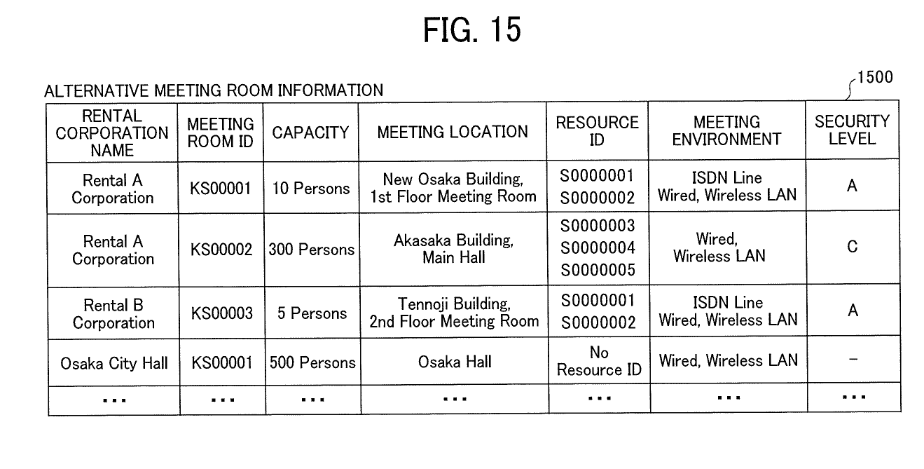

Furthermore, the alternative resource management unit 1301 acquires information on alternative meeting rooms from the resource information 41 managed by the resource management apparatus 31 of a rental company, for example. The alternative resource management unit 1301 assigns a security level to the acquired information on alternative meeting rooms. The alternative resource management unit 1301 stores and manages the information on alternative meeting rooms associated with the security level in alternative meeting room information 1500 as illustrated in FIG. 15.

The information on alternative resources managed by the alternative resource management unit 1301 is used as information to be provided by the information providing unit 315, when the meeting resources managed by the resource management apparatus 120 include no available meeting resource that matches conditions for holding a meeting.

Operation:

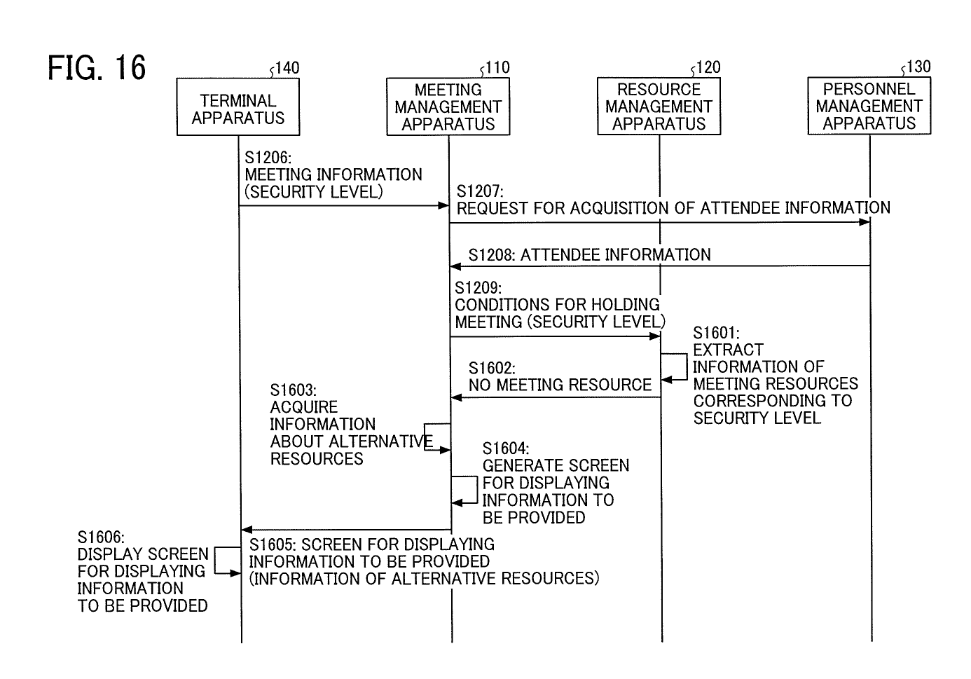

FIG. 16 is a sequence diagram illustrating an example of an information providing process, according to the second embodiment. The process from S1206 to S1209 in FIG. 16 are the same or substantially the same as those illustrated in the sequence diagram of FIG. 12 according to the first embodiment. Accordingly, a redundant description thereof is omitted below, and a description is given of differences between the second embodiment and the first embodiment.

In step S1601, the meeting room management unit 323 and the device management unit 324 of the resource management apparatus 120 retrieve information on the meeting resources that satisfy the conditions for holding a meeting received from the meeting management apparatus 110. However, in this embodiment, it is assumed that no information on the meeting resources that satisfy conditions for holding a meeting is retrieved. In step S1602, the resource management apparatus 120 transmits, to the meeting management apparatus 110, information indicating that there is no meeting resource that satisfies the conditions for holding a meeting.

In step S1603, when the meeting resource management unit 314 of the meeting management apparatus 110 acquires no information on meeting resources that satisfy the conditions for holding a meeting from the resource management apparatus 120, the meeting resource management unit 314 acquires information on alternative resources that satisfy conditions for holding a meeting from the alternative resource management unit 1301.

For example, it is assumed that a user who is going to hold a meeting sets a videoconference with a security level “A” as conditions for holding the meeting. Further, for example, it is assumed that a device for videoconference is not registered in the device information 910 managed by the device management unit 324 of the resource management apparatus 120, as illustrated in FIG. 9A. In this case, the meeting resource management unit 314 acquires, from the alternative device information 1410 as illustrated in FIG. 14A managed by the alternative resource management unit 1301, information on alternative devices whose device IDs are “D00001” and “D0002”, each having a videoconferencing function and associated with the security level “A”.

In step S1604, the information providing unit 315 of the meeting management apparatus 110 generates a display screen for providing information including the information on the alternative resources acquired in step S1603. For example, the information providing unit 315 generates a meeting information registration screen, on which information on the available alternative resources that match the security level of the meeting is displayed.

In steps S1605 and S1606, the information providing unit 315 causes the terminal apparatus 140 to display the generated display screen for providing information.

With the process described above with reference to FIG. 16, even when there is no meeting resource that matches the security level of the meeting, a user who is going to hold the meeting can consider holding the meeting that matches the security level of the meeting by purchasing or renting meeting resources.

### Third Embodiment

In a conventional conference system, for example, a user who is going to hold a meeting sets a security setting corresponding to a security level of the meeting to meeting resources such as meeting devices before a start of the meeting. However, in some cases, general users are not familiar with the security setting of meeting resources such as meeting devices. For this reason, it sometimes takes time to configure security settings, and therefore a start of the meeting is delayed.

To address such issue, in this third embodiment, a description is given of an example in which the information providing system 1 automatically performs security setting of meeting resources before a start of a meeting.

<Functional Configuration>

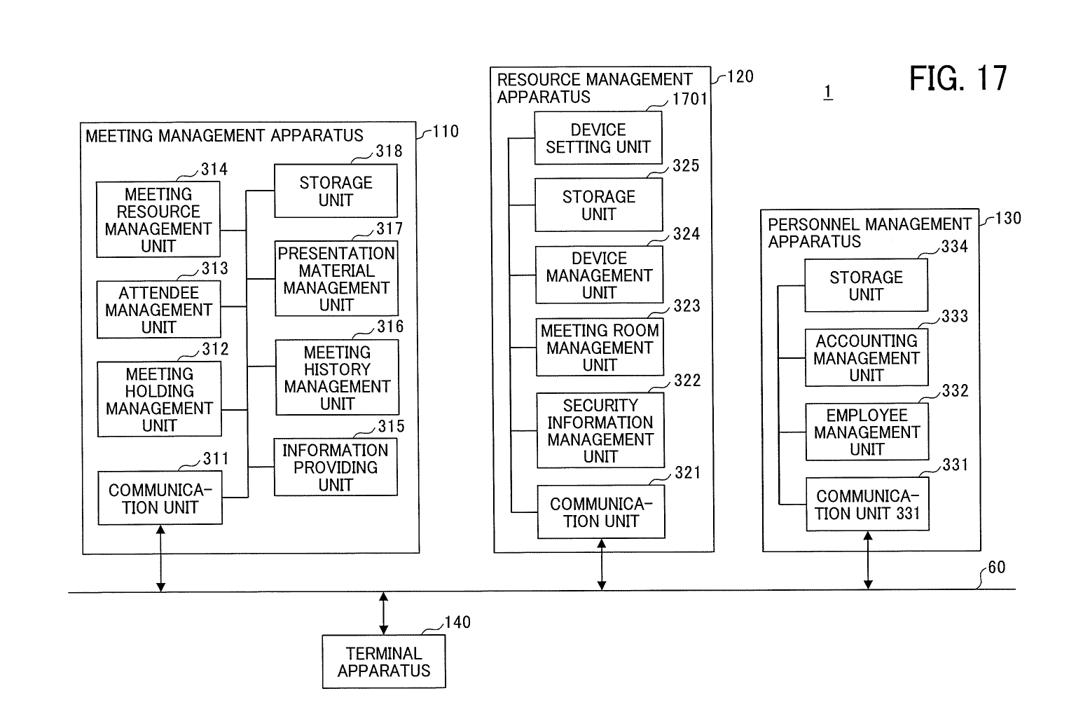

FIG. 17 is a block diagram illustrating an example of a functional configuration of the information providing system 1 according to the third embodiment of the present disclosure. As illustrated in FIG. 17, the resource management apparatus 120 according to the third embodiment includes a device setting unit 1701 in addition to the functional configuration of the resource management apparatus 120 according to the first embodiment illustrated in FIG. 3.

The device setting unit 1701 is implemented by, for example, a program executed by the CPU 201 of FIG. 2. The device setting unit 1701 performs security setting corresponding to a security level of a meeting on meeting resources to be used in the meeting.

Operation:

Meeting Resource Setting Process 1:

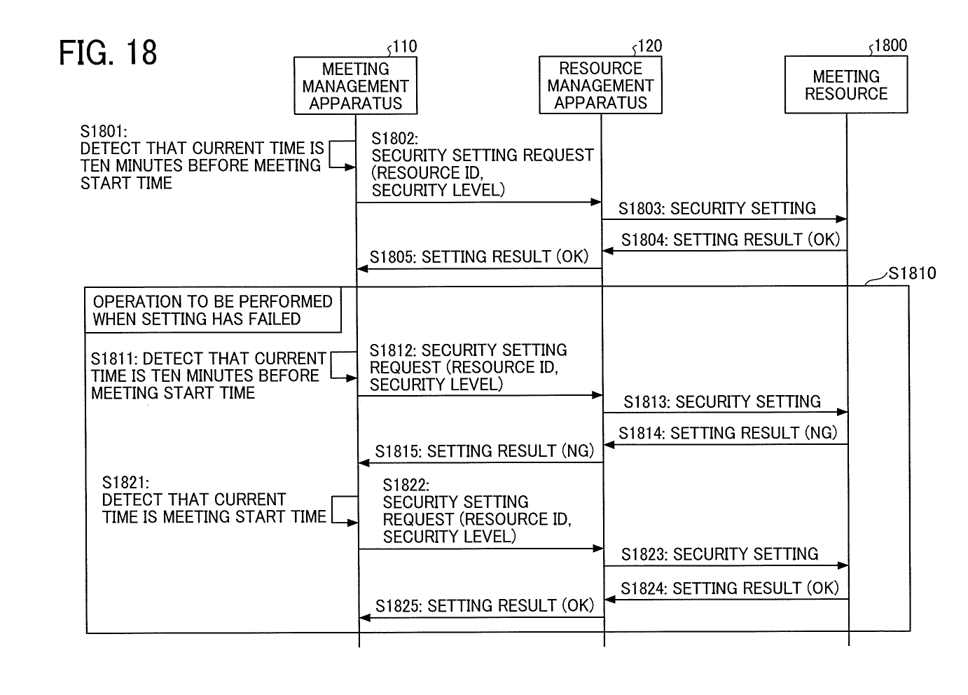

FIG. 18 is a sequence diagram illustrating an example of a meeting resource setting process according to the third embodiment.

In step S1801, the meeting holding management unit 312 of the meeting management apparatus 110 detects that the current time is a predetermined time (e.g., ten minutes) before a start of a meeting, using the meeting holding information 410 as illustrated in FIG. 4A, for example.

In step S1802, the meeting resource management unit 314 of the meeting management apparatus 110 transmits a security setting request to the resource management apparatus 120. The security setting request includes a security level of the meeting to be started in ten minutes and a resource ID of meeting resource to be used in the meeting. Specifically, the meeting resource management unit 314 acquires the security level of the meeting from the meeting holding information 410 as illustrated in FIG. 4A. In addition, the meeting resource management unit 314 acquires, from the resource reservation information 710 as illustrated in FIG. 7A, the resource ID of the meeting resource to be used in the meeting associated with the meeting ID of the meeting to be started in ten minutes.

In step S1803, in response to receiving the security setting request from the meeting management apparatus 110, the device setting unit 1701 of the resource management apparatus 120 performs security setting corresponding to the specified security level on a meeting resource 1800 whose resource ID is the specified resource ID.

In step S1804, the meeting resource 1800 sets the specified security setting (e.g., the presence or absence of encryption, the presence or absence of authentication, etc.) and transmits a setting result indicating that the security setting is completed to the resource management apparatus 120.

In step S1805, the resource management apparatus 120 transmits, to the meeting management apparatus 110, the setting result indicating that the security setting is completed.

With the process from S1801 to S1805, the information providing system 1 can automatically perform security setting corresponding to a security level of a meeting on meeting resources to be used in the meeting before a start time of the meeting.

There is a case in which the meeting resource 1800 fails to perform security setting before starting the meeting, such as when the power of the meeting resource 1800 is off, or when the meeting resource 1800 is in use at another meeting. In this case, the information providing system 1 performs a process 1810 illustrated in FIG. 18. The process 1810 is a process to be performed when the security setting has failed.

For example, in step S1811, the meeting holding management unit 312 of the meeting management apparatus 110 detects that the current time is a predetermined time (e.g., ten minutes) before a start of a meeting, using the meeting holding information 410 as illustrated in FIG. 4A.

In step S1812, the meeting resource management unit 314 of the meeting management apparatus 110 transmits a security setting request to the resource management apparatus 120. The security setting request includes a security level of the meeting to be started in ten minutes and a resource ID of meeting resource to be used in the meeting.

In step S1813, in response to receiving the security setting request from the meeting management apparatus 110, the device setting unit 1701 of the resource management apparatus 120 performs security setting corresponding to the specified security level on the meeting resource 1800 whose resource ID is the specified resource ID.

In step S1814, it is assumed that since the meeting resource 1800 fails to perform the specified security setting (e.g., the presence or absence of encryption, the presence or absence of authentication, etc.), the meeting resource 1800 transmits, to the resource management apparatus 120, a setting result indicating that the security setting cannot be performed.

In step S1815, the resource management apparatus 120 transmits, to the meeting management apparatus 110, the setting result indicating that the security setting cannot be performed.

In this case, the meeting management apparatus 110 waits until the meeting start time arrives. Then, in step S1821, the meeting management apparatus 110 detects that the current time is the meeting start time.

In step S1822, the meeting resource management unit 314 of the meeting management apparatus 110 transmits a security setting request to the resource management apparatus 120. The security setting request includes a security level of the meeting to be started at the state time and a resource ID of meeting resource to be used in the meeting.

In step S1823, in response to receiving the security setting request from the meeting management apparatus 110, the device setting unit 1701 of the resource management apparatus 120 performs security setting corresponding to the specified security level on the meeting resource 1800 whose resource ID is the specified resource ID.

In step S1824, the meeting resource 1800 sets the specified security setting (e.g., the presence or absence of encryption, the presence or absence of authentication, etc.) and transmits a setting result indicating that the security setting is completed to the resource management apparatus 120.

In step S1825, the resource management apparatus 120 transmits, to the meeting management apparatus 110, the setting result indicating that the security setting is completed.

A description is given above of an example in which the meeting management apparatus 110 detects that the current time is the meeting start time in step S1821. In another example, the meeting management apparatus 110 detects that the current time is within a predetermined time (e.g., 1-5 minutes) from the meeting start time in step S1821.

With the process described above, even when a user is not familiar with configuring security settings of meeting resources such as meeting devices, the information providing system 1 automatically performs security setting. This prevents the start of a meeting from being delayed.

It is considered that at the time of step S1823 in FIG. 18, the power of the meeting resource 1800 is on and is not used at other meetings. Accordingly, it is more likely that security setting succeeds. In another example, when the setting result indicating that the security setting has failed is notified in step S1814, the meeting management apparatus 110 retries the security setting a predetermined time (e.g., 1 to 5 minutes) after receiving the setting result.

Meeting Resource Setting Process 2:

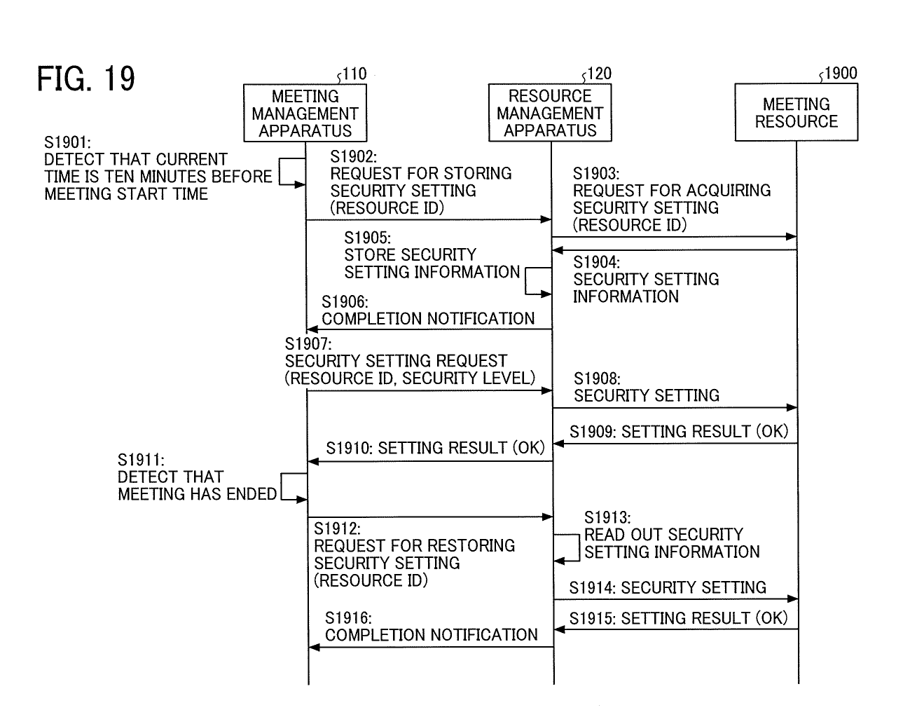

FIG. 19 is a sequence diagram illustrating another example of a meeting resource setting process according to the third embodiment. This process is an example of a process in which security settings of meeting resource is restored from those configured before a start of a meeting to original security settings after the meeting ends.

In step S1901, the meeting holding management unit 312 of the meeting management apparatus 110 detects that the current time is a predetermined time (e.g., ten minutes) before a start of a meeting, using the meeting holding information 410 as illustrated in FIG. 4A, for example.

In step S1902, the meeting resource management unit 314 of the meeting management apparatus 110 transmits a security setting storage request to the resource management apparatus 120. The security setting storage request includes a resource ID of meeting resource to be used in the meeting to be started in ten minutes.

In steps S1903 and S1904, in response to receiving the security setting storage request from the meeting management apparatus 110, the device setting unit 1701 of the resource management apparatus 120 acquires security setting information from a meeting resource 1900 whose resource ID is the specified resource ID.

In step S1905, the device setting unit 1701 stores the acquired security setting information of the meeting resource 1900 in the cloud A 20, for example. In another example, the device setting unit 1701 stores the acquired security setting information of the meeting resource 1900 in the storage unit 325.

In step S1906, the device setting unit 1701 transmits, to the meeting management apparatus 110, a completion notification indicating that the security settings are successfully saved.

In step S1907, the meeting resource management unit 314 of the meeting management apparatus 110 transmits a security setting request to the resource management apparatus 120. The security setting request includes a security level of the meeting to be started in ten minutes and a resource ID of meeting resource to be used in the meeting.

In step S1908, in response to receiving the security setting request from the meeting management apparatus 110, the device setting unit 1701 of the resource management apparatus 120 performs security setting corresponding to the specified security level on the meeting resource 1900 whose resource ID is the specified resource ID.

In step S1909, the meeting resource 1900 sets the specified security setting (e.g., the presence or absence of encryption, the presence or absence of authentication, etc.) and transmits a setting result indicating that the security setting is completed to the resource management apparatus 120.

In step S1910, the resource management apparatus 120 transmits, to the meeting management apparatus 110, the setting result indicating that the security setting is completed.

Further, for example, in step S1911, the meeting holding management unit 312 of the meeting management apparatus 110 detects an end of the meeting.

In step S1912, the meeting resource management unit 314 of the meeting management apparatus 110 transmits a security setting restoration request to the resource management apparatus 120. The security setting restoration request includes a resource ID of the meeting resource 1900 that is used in the ended meeting.

In step S1913, in response to receiving the security setting restoration request from the meeting management apparatus 110, the device setting unit 1701 of the resource management apparatus 120 reads out the security setting information of the meeting resource 1900 from, for example, the cloud A 20, using the specified resource ID.

In step S1914, the device setting unit 1701 of the resource management apparatus 120 sets the read-out security setting information of the meeting resource 1900 in the meeting resource 1900.

In step S1915, the meeting resource 1900 restores security settings using the specified security setting information and transmits a setting result indicating that the restoration of the security setting is completed to the resource management apparatus 120.

In step S1916, the resource management apparatus 120 transmits, to the meeting management apparatus 110, a completion notification indicating that the restoration of security settings is completed.

With the process from S1901 to S1916, the information providing system 1 can restore the security settings of the meeting resource 1900 from those configured before a start of a meeting to the original security settings after the meeting is ended.

Meeting Resource Setting Process 3:

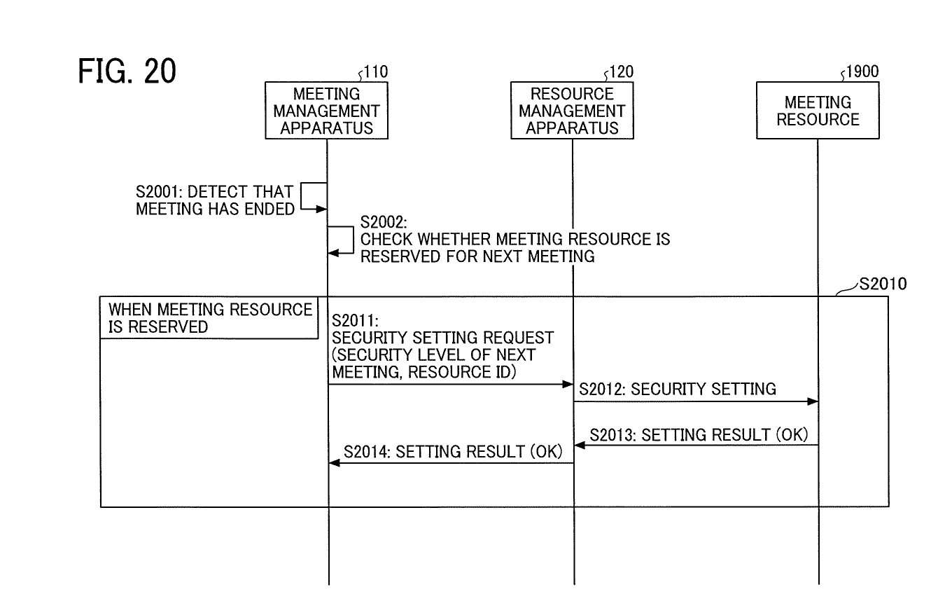

FIG. 20 is a sequence diagram illustrating still another example of a meeting resource setting process according to the third embodiment. This process is an example of a process in which the information providing system 1 automatically sets security settings of meeting resource to security settings corresponding to the security level of the next meeting after a meeting is ended.

In step S2001, the meeting holding management unit 312 of the meeting management apparatus 110 detects an end of a meeting.

In step S2002, the meeting holding management unit 312 determines whether the meeting resource 1900 that is used in the ended meeting is reserved for the next meeting. In a case where the meeting resource 1900 is not reserved for the next meeting, the information providing system 1 performs the security setting restoration process in the same or substantially the same manner as from S1912 to S1916 illustrated in FIG. 19, for example. By contrast, in a case where the meeting resource is reserved for the next meeting, the information providing system 1 performs a process 2010 illustrated in FIG. 20. The process 2010 is a process to be performed when the meeting resource 1900 is reserved for the next meeting.

For example, in step S2011, the meeting resource management unit 314 of the meeting management apparatus 110 transmits a security setting request to the resource management apparatus 120. The security setting request includes a security level of the next meeting and a resource ID of meeting resource to be used in the next meeting.

In step S2012, in response to receiving the security setting request from the meeting management apparatus 110, the device setting unit 1701 of the resource management apparatus 120 performs security setting corresponding to the specified security level on the meeting resource 1900 whose resource ID is the specified resource ID.

In step S2013, the meeting resource 1900 sets the specified security setting (e.g., the presence or absence of encryption, the presence or absence of authentication, etc.) and transmits a setting result indicating that the security setting is completed to the resource management apparatus 120.

In step S2014, the resource management apparatus 120 transmits, to the meeting management apparatus 110, the setting result indicating that the security setting is completed.

Meeting Resource Setting Process 4:

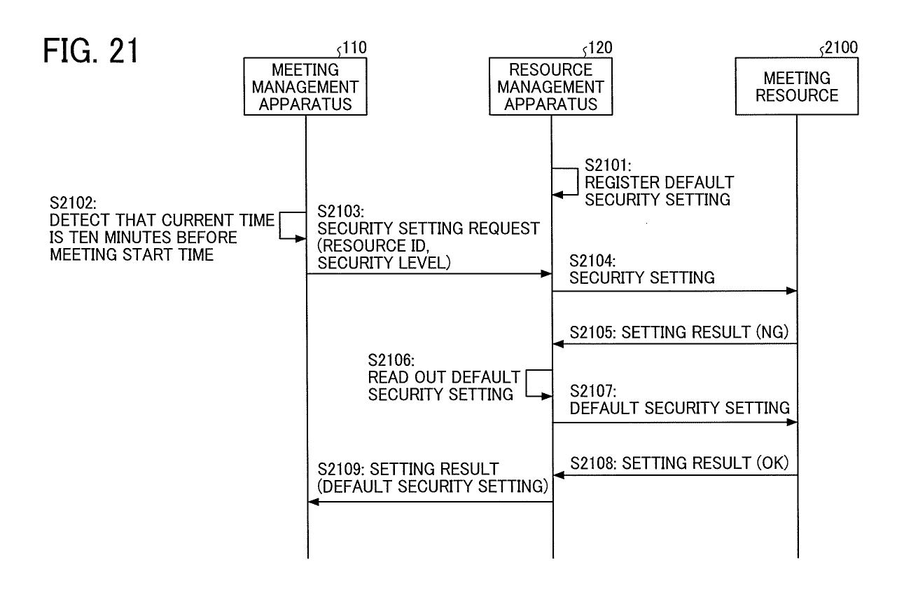

FIG. 21 is a sequence diagram illustrating still another example of a meeting resource setting process according to the third embodiment. This process is example of a process in which, when security setting corresponding to a security level cannot be performed on meeting resource, security settings of the meeting resource is set to default security settings.

In step S2101, the resource management apparatus 120 stores a default security setting of meeting resource 2100 in advance in the cloud A 20, the storage unit 325, or the like.

In step S2102, the meeting holding management unit 312 of the meeting management apparatus 110 detects that the current time is a predetermined time (e.g., ten minutes) before a start of a meeting, using the meeting holding information 410 as illustrated in FIG. 4A, for example.

In step S2103, the meeting resource management unit 314 of the meeting management apparatus 110 transmits a security setting request to the resource management apparatus 120. The security setting request includes a security level of the meeting to be started in ten minutes and a resource ID of the meeting resource 2100 to be used in the meeting.

In step S2104, in response to receiving the security setting request from the meeting management apparatus 110, the device setting unit 1701 of the resource management apparatus 120 performs security setting corresponding to the specified security level on the meeting resource 2100 whose resource ID is the specified resource ID.

In step S2105, it is assumed that since the meeting resource 2100 fails to perform the specified security setting, the meeting resource 2100 transmits, to the resource management apparatus 120, a setting result indicating that the security setting cannot be performed.

In step S2106, the device setting unit 1701 of the resource management apparatus 120 reads out the default security setting of the meeting resource 2100 that is stored in advance in the cloud A 20, the storage unit 325 or the like.

In step S2107, the device setting unit 1701 of the resource management apparatus 120 performs the read-out default security setting on the meeting resource 2100.

In step S2108, the meeting resource 2100 performs the specified default security setting and transmits a setting result indicating that the setting of the default security setting is completed to the resource management apparatus 120.

In step S2109, the resource management apparatus 120 transmits, to the meeting management apparatus 110, a completion notification indicating that the security setting is set to the default security setting.

With the process from S2101 to S2109, even when security setting corresponding to the security level cannot be performed on meeting resources, a meeting can be held.

Meeting Resource Setting Process 5:

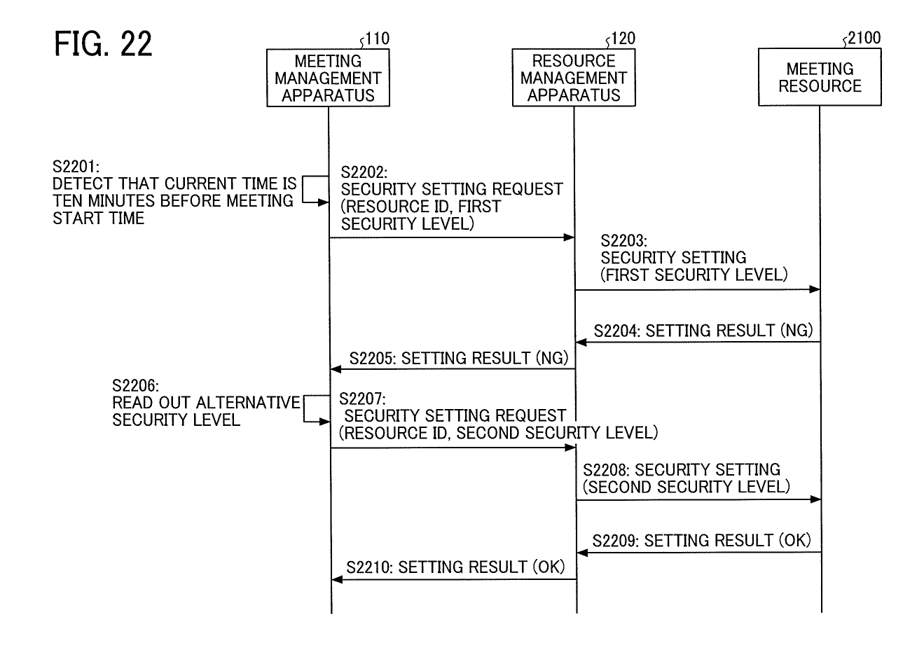

FIG. 22 is a sequence diagram illustrating still another example of a meeting resource setting process according to the third embodiment. This processing is an example of a process in which when a security setting corresponding to a first security level cannot be applied to meeting resource 2200, a security setting corresponding to a second security level is applied to the meeting resource 2200. Security contents of the second security level are less restrictive than security contents of the first security level.

In step S2201, the meeting holding management unit 312 of the meeting management apparatus 110 detects that the current time is a predetermined time (e.g., ten minutes) before a start of a meeting, using the meeting holding information 410 as illustrated in FIG. 4A, for example.

In step S2202, the meeting resource management unit 314 of the meeting management apparatus 110 transmits a security setting request to the resource management apparatus 120. The security setting request includes a first security level of the meeting to be started in ten minutes and a resource ID of the meeting resource 2200 to be used in the meeting.

In step S2203, in response to receiving the security setting request from the meeting management apparatus 110, the device setting unit 1701 of the resource management apparatus 120 performs security setting corresponding to the specified first security level on the meeting resource 2200 whose resource ID is the specified resource ID.

In step S2204, it is assumed that since the meeting resource 2200 fails to perform security setting corresponding to the specified first security level, the meeting resource 2200 transmits, to the resource management apparatus 120, a setting result indicating that the security setting cannot be performed.

In step S2205, the device setting unit 1701 of the resource management apparatus 120 transmits, to the meeting management apparatus 110, the setting result indicating that the security setting corresponding to the first security level cannot be performed.

In step S2206, the meeting resource management unit 314 of the meeting management apparatus 110 reads out the second security level. Security contents of the second security level are less restrictive than security contents of the first security level of the meeting resource 2200. The first security level is an example of a first setting. The second security level is an example of a second setting that is different from the first setting.

In step S2207, the meeting resource management unit 314 of the meeting management apparatus 110 transmits a security setting request to the resource management apparatus 120. The security setting request includes the second security level and the resource ID of the meeting resource 2200.

In step S2209, the meeting resource 2200 performs security setting corresponding to the specified second security level and transmits a setting result indicating that the security setting is completed to the resource management apparatus 120.

In step S2210, the resource management apparatus 120 transmits, to the meeting management apparatus 110, a completion notification indicating that the security setting corresponding to the second security level is completed.

With the process from S2201 to S2210, situations where a meeting cannot be started since security setting of meeting resource cannot be performed or situation where a meeting is held with no security setting are reduced, for example.

A conventional conference system allows a user to hold a remote conference at various places. However, in such a conference system, it is difficult to secure an appropriate security level based on conference contents.

According to one or more embodiments of the present disclosure, an appropriate security level is secured depending on contents of a meeting by providing information on meeting resources that satisfy conditions for holding the meeting.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information providing system, comprising one or more processors configured to:
store, in a memory, for each of one or more meeting resources, information on the meeting resource and security information of the meeting resource in association with each other;
receive an input of a meeting holding condition;
acquire information on at least one of the one or more meeting resources that matches the meeting holding condition from among the one or more meeting resources based on security information corresponding to the meeting holding condition; and
provide the information on the at least one of the one or more meeting resources.

2. The information providing system of claim 1,
wherein the one or more processors are further configured to:
receive the meeting holding condition including security information; and
acquire the information on the at least one of the one or more meeting resources corresponding to the security information included in the meeting holding condition.

3. The information providing system of claim 1, wherein the one or more processors are further configured to:
store, in the memory, for each of one or more alternative resources, information on the alternative resource and security information of the alternative resource;
acquire information on at least one of the one or more alternative resources that matches the meeting holding condition from among the one or more alternative resources, when the one or more processors fail to acquire the information on the at least one of the one or more meeting resources that matches the meeting holding condition; and
provide the information on the at least one of the one or more alternative resource.

4. The information providing system of claim 3, wherein
the one or more processors acquire the information on the one or more alternative resources substitutable for the one or more meeting resources from an external server and assign security information to each of the one or more alternative resources.

5. The information providing system of claim 1, wherein
the one or more meeting resources include at least one of a place where a meeting is held, a device to be used in the meeting, and a program to be used in the meeting.

6. The information providing system of claim 1, wherein
the meeting holding condition includes information on a start time of a meeting, and
the one or more processors are further configured to perform, on the at least one of the one or more meeting resources to be used in the meeting, setting corresponding to the security information, before the start time of the meeting.

7. The information providing system of claim 6, wherein
when the one or more processors fail to perform the setting corresponding to the security information on the at least one of the one or more meeting resources to be used in the meeting before the start time of the meeting, the one or more processors are configured to perform the setting on the at least one of the one or more meeting resources at the start time of the meeting or within a predetermined time from the start time of the meeting.

8. The information providing system of claim 6, wherein
the one or more processors are further configured to restore a setting of the at least one of the one or more meeting resources to a previous setting being configured before performing the setting corresponding to the security information, after the meeting ends.

9. The information providing system of claim 6, wherein
when the one or more processors fail to perform first setting corresponding to the security information on the at least one of the one or more meeting resources to be used in the meeting, the one or more processors are configured to perform one of default setting and second setting having security contents that are less restrictive than security contents of the first setting.

10. An information providing apparatus, comprising one or more processors configured to:
store, in a memory, for each of one or more meeting resources, information on the meeting resource and security information of the meeting resource;
receive an input of a meeting holding condition;
acquire information on at least one of the one or more meeting resources that matches the meeting holding condition from among the one or more meeting resources based on security information corresponding to the meeting holding condition; and
provide the information on the at least one of the one or more meeting resources.

11. A method of providing information performed by a computer, the method comprising:
storing, in a memory, for each of one or more meeting resources, information on the meeting resource and security information of the meeting resource;
receiving an input of a meeting holding condition;
acquiring information on at least one of the one or more meeting resources that matches the meeting holding condition from among the one or more meeting resources based on security information corresponding to the meeting holding condition; and
providing the information on the at least one of the one or more meeting resources.
